(19) United States
(12) Patent Application Publication
(10) Pub. No.: US 2025/0252478 A1
(43) Pub. Date: Aug. 7, 2025

(54) DATA PROCESSING METHOD AND APPARATUS, DEVICE, AND READABLE STORAGE MEDIUM

(71) Applicant: TENCENT TECHNOLOGY (SHENZHEN) COMPANY LIMITED, Shenzhen (CN)

(72) Inventor: Hongjian ZOU, Shenzhen (CN)

(21) Appl. No.: 19/191,072

(22) Filed: Apr. 28, 2025

Related U.S. Application Data
(63) Continuation of application No. PCT/CN2024/076929, filed on Feb. 8, 2024.

(30) Foreign Application Priority Data
Mar. 24, 2023 (CN) 202310328766.1

(51) Int. Cl. G06Q 30/0601

(52) U.S. Cl. CPC G06Q 30/0631; G06Q 30/0639

(57) ABSTRACT

A data processing method includes: obtaining a service surface activity feature of an object in a service, and inputting the service surface activity feature to a deep mining and analysis model, the deep mining and analysis model being configured to deeply mine one or more factor semantic representation features for a surface activity feature based on a configuration affecting factor system of the service; performing deep mining and analysis processing on the service surface activity feature in the deep mining and analysis model based on the configuration affecting factor system, to obtain a factor semantic representation feature of the service surface activity feature for each configuration affecting factor; and outputting a service policy of the object for the service and policy interpretation information for the service policy based on the factor semantic representation feature of the service surface activity feature for each configuration affecting factor.

### CROSS-REFERENCES TO RELATED APPLICATIONS

This application is a continuation of PCT Application No. PCT/CN2024/076929, filed on Feb. 8, 2024, which claims priority to Chinese Patent Application No. 2023103287661, entitled “DATA PROCESSING METHOD AND APPARATUS, DEVICE, AND READABLE STORAGE MEDIUM” and filed with the China National Intellectual Property Administration on Mar. 24, 2023, the entire contents of both of which are incorporated herein by reference.

### FIELD OF THE TECHNOLOGY

The present disclosure relates to the field of computer technologies, and in particular, to a data processing method and apparatus, a device, and a readable storage medium.

### BACKGROUND OF THE DISCLOSURE

In the field of artificial intelligence (AI), a machine learning technology (especially, a deep learning technology) is an important research technology, and the machine learning technology plays an important role in many service scenarios (for example, a financial service scenario, a medical service scenario, and a media data recommendation service scenario). Specifically, a prediction result in a service scenario may be outputted by using a machine learning model, and a related object (for example, a user) may be assisted in making an important decision in the service scenario based on the prediction result.

However, most machine learning models (for example, a deep model and a complex non-linear model) are models without interpretability. Prediction processes of the models without interpretability are black-box operations, and prediction logic of the models is not transparent. In this case, it is not disclosed that prediction results outputted by the models are affected by factors. As a result, a model without interpretability may likely perform prediction based on incorrect prediction logic, and an outputted prediction result is incorrect and inaccurate. In other words, credibility of an output result of the model is not high enough. When the prediction result of the model does not have much credibility, a service decision determined based on the prediction result also has low accuracy.

### SUMMARY

Embodiments of the present disclosure provide a data processing method and apparatus, a device, and a readable storage medium, so that in a task of determining a service policy, credibility of the determined service policy can be improved.

An aspect of the embodiments of the present disclosure provides a data processing method, including: obtaining a service surface activity feature of an object in a service, and inputting the service surface activity feature to a deep mining and analysis model, the service surface activity feature being a behavior activity feature of the object directly corrected in the service, the deep mining and analysis model being configured to deeply mine one or more factor semantic representation features for a surface activity feature based on a configuration affecting factor system of the service, the configuration affecting factor system including one or more configuration affecting factors that affect the surface activity feature; performing deep mining and analysis processing on the service surface activity feature in the deep mining and analysis model based on the configuration affecting factor system, to obtain a factor semantic representation feature of the service surface activity feature for each configuration affecting factor, a factor semantic representation feature for one configuration affecting factor representing a deep feature of semantics of the configuration affecting factor; and outputting a service policy of the object for the service and policy interpretation information for the service policy based on the factor semantic representation feature of the service surface activity feature for each configuration affecting factor, wherein the policy interpretation information interprets a calculation logic of the service policy.

An aspect of the embodiments of the present disclosure provides a data processing apparatus, including: a feature obtaining module, configured to obtain a service surface activity feature of an object in a service, the service surface activity feature being a behavior activity feature of the object directly corrected in the service; a feature input module, configured to input the service surface activity feature to a deep mining and analysis model, the deep mining and analysis model being configured to deeply mine one or more factor semantic representation features for a surface activity feature based on a configuration affecting factor system of the service, the configuration affecting factor system including one or more configuration affecting factors that affect the surface activity feature; a feature analysis module, configured to perform deep mining and analysis processing on the service surface activity feature in the deep mining and analysis model based on the configuration affecting factor system, to obtain a factor semantic representation feature of the service surface activity feature for each configuration affecting factor, a factor semantic representation feature for one configuration affecting factor representing a deep feature of semantics of the configuration affecting factor; and a policy output module, configured to output a service policy of the object for the service and policy interpretation information for the service policy based on the factor semantic representation feature of the service surface activity feature for each configuration affecting factor, wherein the policy interpretation information interprets a calculation logic of the service policy.

An aspect of the embodiments of the present disclosure provides a computer device, including: a processor and a memory, the memory storing a computer program, and the computer program, when executed by the processor, causing the processor to perform the method according to the embodiments of the present disclosure.

An aspect of the embodiments of the present disclosure provides a non-transitory computer-readable storage medium, storing a computer program, the computer program including program instructions, and the program instructions, when executed by a processor, implementing the method according to the embodiments of the present disclosure.

In the embodiments of the present disclosure, when a service policy for a service is formulated for an object, a service surface activity feature of the object in the service may be first obtained, and deep mining and analysis processing may be performed on the service surface activity feature by using a deep mining and analysis model, so that the service surface activity feature may be converted into one or more deep factor semantic representation features. Subsequently, the service policy of the object in the service may be determined based on the factor semantic representation features. Moreover, policy interpretation information (information configured for interpreting the service policy) for the service policy may be outputted based on the factor semantic representation features. In the present disclosure, a configuration affecting factor system of a service may be constructed, and then a service surface activity feature of an object in the service may be converted into a deep factor semantic representation feature by using a deep mining and analysis model. A service policy of the object for the service is determined and outputted based on the deep factor semantic representation feature instead of being determined based on a surface activity feature, thereby better improving accuracy of the service policy. In addition, in the present disclosure, when the service policy is determined and outputted, policy interpretation information for the service policy may be further outputted. A reason for determining the service policy may be well explained by using the policy interpretation information, so that determining logic of the service policy can be presented intuitively, and credibility of the service policy can be improved well. In addition, because the policy interpretation information is determined based on the deep factor semantic representation feature, an interpretation level of the policy interpretation information is also relatively high, thereby further improving the credibility of the service policy. Based on the foregoing, in the present disclosure, in a task of determining a service policy, credibility of the determined service policy can be improved.

### BRIEF DESCRIPTION OF THE DRAWINGS

FIG. 1 is a diagram of a network architecture according to an embodiment of the present disclosure.

FIG. 2 is a schematic flowchart of a data processing method according to an embodiment of the present disclosure.

FIG. 3 is a schematic diagram of a correspondence between a surface activity feature and a factor semantic representation feature according to an embodiment of the present disclosure.

FIG. 4 is a schematic diagram of a correspondence between a detailed surface feature and a factor semantic representation feature according to an embodiment of the present disclosure.

FIG. 5 is a schematic flowchart of performing semantic constraint processing on a factor semantic representation feature according to an embodiment of the present disclosure.

FIG. 6 is a schematic flowchart of another data processing method according to an embodiment of the present disclosure.

FIG. 7 is a schematic diagram of a system process according to an embodiment of the present disclosure.

FIG. 8 is a diagram of a system architecture of constructing an interpretable task model according to an embodiment of the present disclosure.

FIG. 9 is a schematic structural diagram of a data processing apparatus according to an embodiment of the present disclosure.

FIG. 10 is a schematic structural diagram of another data processing apparatus according to an embodiment of the present disclosure.

FIG. 11 is a schematic structural diagram of a computer device according to an embodiment of the present disclosure.

### DESCRIPTION OF EMBODIMENTS

Embodiments of the present disclosure relate to artificial intelligence and related concepts. For ease of understanding, the following briefly describes the artificial intelligence and the related concepts first.

The artificial intelligence (AI) is a theory, a method, a technology, and an application system that uses a digital computer or a machine controlled by the digital computer to simulate, extend, and expand human intelligence, perceive an environment, acquire knowledge, and use the knowledge to obtain an optimal result. In other words, the AI is a comprehensive technology in computer science and attempts to understand the essence of intelligence and produce a new intelligent machine that can react in a manner similar to human intelligence. The AI is to study the design principles and implementation methods of various intelligent machines, so that the machines have the functions of perception, reasoning, and decision-making.

The AI technology is a comprehensive discipline, and relates to a wide range of fields including both hardware-level technologies and software-level technologies. The basic AI technologies generally include technologies such as a sensor, a dedicated AI chip, cloud computing, distributed storage, a big data processing technology, an operating/interaction system, and electromechanical integration. AI software technologies mainly include several major directions such as a computer vision (CV) technology, a speech processing technology, a natural language processing technology, and machine learning/deep learning.

With the research and progress of artificial intelligence (AI) technologies, the AI technology is studied and applied in a plurality of fields such as a common smart home, a smart wearable device, a virtual assistant, a smart speaker, smart marketing, unmanned driving, automatic driving, an unmanned aerial vehicle, a robot, smart medical care, and smart customer service. It is believed that with the development of technologies, the AI technology will be applied to more fields, and play an increasingly important role.

Solutions provided in the embodiments of the present disclosure belong to machine learning (ML) in the AI field.

Machine learning (ML) is a multi-field interdiscipline, and relates to a plurality of disciplines such as the probability theory, statistics, the approximation theory, convex analysis, and the algorithm complexity theory. The ML specializes in studying how a computer simulates or implements a human learning behavior to obtain new knowledge or skills, and reorganize an existing knowledge structure, so as to keep improving its performance. The machine learning is a core of the AI, is a basic way to make the computer intelligent, and is applied to various fields of the AI. The machine learning and deep learning generally include technologies such as an artificial neural network, a belief network, reinforcement learning, transfer learning, inductive learning, and learning from demonstrations.

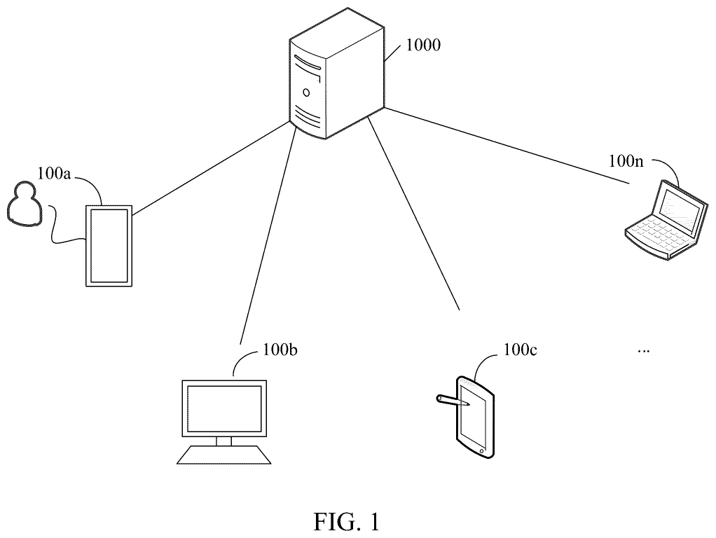

For ease of understanding, FIG. 1 is a diagram of a network architecture according to an embodiment of the present disclosure. As shown in FIG. 1, the network architecture may include a service server 1000 and a terminal device cluster. The terminal device cluster may include one or more terminal devices. A quantity of terminal devices is not limited herein. As shown in FIG. 1, a plurality of terminal devices may include a terminal device 100a, a terminal device 100b, a terminal device 100c, . . . , and a terminal device 100n. As shown in FIG. 1, the terminal device 100a, the terminal device 100b, the terminal device 100c, . . . , and the terminal device 100n each may be in a network connection with the service server 1000, so that each terminal device may exchange data with the service server 1000 through the network connection.

As shown in FIG. 1, a target application may be installed on each terminal device. When running in each terminal device, the target application may exchange data with the service server 1000 shown in FIG. 1 respectively, so that the service server 1000 may receive service data from each terminal device. The target application may include an application having a function of displaying data information such as a text, an image, audio, and a video. The application may include a multimedia application (for example, a video application), and may be used by a user to upload a picture or a video, or may be used by the user to play and watch an image or a video uploaded by another person. The application may alternatively be an entertainment application (for example, a game application), and may be used by a user to play a game. In addition, the application may alternatively be any application having a data processing function, for example, an education application, a communication application, a shopping application, or a browser application. All of these applications may have multimedia data (for example, a picture, a video, or music) loading and playing functions. For example, the application may be a communication application, an education application, a short video application, or a game application. The application may be an applet, that is, an independent program that can be run only after being downloaded into a browser environment. Certainly, the application may be an independent application, or may be a child application (for example, an applet) embedded in an application, and the child application may be controlled by a user to run or close. In conclusion, the application may be an application, a module, or a plug-in in any form. This is not limited.

In one embodiment of the present disclosure, one terminal device may be selected from the plurality of terminal devices as a target terminal device. The terminal device may include: an intelligent terminal carrying a multimedia data processing function (for example, a video data playing function, a music data playing function, and a text data playing function), such as a smartphone, a tablet computer, a notebook computer, a desktop computer, a smart television, a smart speaker, a desktop computer, a smartwatch, a smart vehicle-mounted device, a smart speech interaction device, and an intelligent appliance, but is not limited thereto. For example, in this embodiment of the present disclosure, the terminal device 100a shown in FIG. 1 may be used as a target terminal device. The target application may be integrated into the target terminal device. In this case, the target terminal device may exchange data with the service server 1000 through the target application. The service server 1000 in the present disclosure may obtain service data according to these applications. For example, the service server 1000 may obtain the service data by using a bound account of a user. The bound account may be an account bound by the user in an application. The user may log in to the application, upload data, obtain data, and the like by using the bound account corresponding to the user. The service server may also obtain a login status of the user and the uploaded data, send data to the user, and the like by using the bound account.

When a user uses a target application (for example, a motion detection application) in a terminal device, the service server 1000 may detect and collect, by using the terminal device, a surface activity feature (the service data obtained by the service server 1000 may be understood as the surface activity feature) generated by the user (which is referred to as an object below) in the target application. For example, the target application is a shopping application, a frequency at which the object starts and runs the shopping application, a frequency at which the object browses an item (for example, a liquid foundation) in the shopping application, and a frequency at which the object purchases an item (for example, a mask) in the shopping application may all be used as surface activity features of the object in the shopping application. In other words, the surface activity feature may be a behavior activity feature (the behavior activity feature may be understood as a feature generated by the object by executing some behaviors in the target application) that can be observed in the target application, the surface activity feature is configured for describing a surface phenomenon (appearance) that can be observed in the target application, and the surface activity feature may be directly collected and obtained. With the development of computer technologies, in a target application, related information may be recommended to an object based on a surface activity feature of the object. For example, in a shopping application, another item associated with an item with a high purchase frequency may be recommended to the object based on an item highly frequently purchased by the object (which may be referred to as the item with a high purchase frequency) (an example in which the item with a high purchase frequency is a liquid foundation, and a makeup product may be recommended to the object based on the liquid foundation).

An appearance behavior of one object may be generated based on different affecting factors. A shopping application is used as an example, a frequency of purchasing an item by an object in the shopping application is relatively high, and each purchased item needs to consume a large quantity of virtual resources (the virtual resource may be a resource that is in a target application and that can be configured for purchasing a related item in the target application, for example, in the shopping application, an item in the shopping application can be purchased by using points and empirical values in the shopping application, and the points and the empirical values in the shopping application can be used as virtual resources and for another example, in a game application, game gold, game points, and game diamond may be configured for purchasing a virtual character in the game application, and then the game gold, the game points, and the game diamond may be used as virtual resources in the game application). In this case, an affecting factor of these behaviors of the object in the shopping application may be that the object has sufficient virtual resources (the object has a relatively large quantity of virtual resources). The shopping application is still used as an example, and a frequency of purchasing a cosmetic item by an object in the shopping application is relatively high. In this case, an affecting factor of the behavior of the object in the shopping application may be that the object has a cosmetic preference. In other words, a reason why an object generates a surface activity feature includes a plurality of affecting factors. Compared with the surface activity feature, these affecting factors can deeply and more accurately reflect related information in the target application.

Based on this, to improve reasonableness of recommending an item to an object in the target application, in the present disclosure, an affecting factor system may be pre-configured for an activity in the target application, to obtain a configuration affecting factor system. The configuration affecting factor system may include different configuration affecting factors (one configuration affecting factor may be an affecting dimension, for example, a virtual resource status dimension of an object, a product quality dimension, or a macro-environment dimension) that affect a behavior activity occurring in the target application. After obtaining a surface activity feature of an object in the target application, the service server 1000 may perform deep mining and analysis on the surface activity feature based on the configuration affecting factor system, to obtain a factor semantic representation feature (the factor semantic representation feature is a deep feature configured for reflecting semantics of a configuration affecting factor) of the surface activity feature for each configuration affecting factor, and then determine a service policy of the object in the target application based on the deep factor semantic representation feature (for example, in a shopping application, determine a recommended item for the object). Certainly, the service policy determined by the service server 1000 for the object may be used as an auxiliary reference value for reference to a related object (an object for formulating a policy) in the target application, to determine a final policy of the object. In the present disclosure, to improve credibility of the service policy determined by the service server 1000, when outputting the service policy of the object, the service server 1000 may further output policy interpretation information for the service policy. The policy interpretation information may be configured for describing a reason for determining the service policy (the service policy is determined based on the factor semantic representation feature). The policy interpretation information may reflect, to some extent, logic of determining the service policy by the service server 1000, and the credibility of the service policy can be better improved based on the policy interpretation information. Therefore, accuracy and reasonableness of a final policy determined by a policy formulation object (an object for formulating a policy) of the target application can be improved.

One target application may correspond to one or more (a plurality of means two or more) services, for example, a shopping application may correspond to a shopping service, a short video application may correspond to a media data recommendation service, and a game application may correspond to an information pushing service. The surface activity feature of the object in the target application may be understood as a surface activity feature of the object in a service. In this case, a surface activity feature of an object may be referred to as a service surface activity feature. For a service surface activity feature of an object, the service server 1000 may specifically perform deep mining and analysis processing on the service surface activity feature by using a deep mining and analysis model, to obtain a deep factor semantic representation feature of the service surface activity feature. For a specific implementation thereof, refer to descriptions in subsequent embodiments.

A method provided in the embodiments of the present disclosure may be applied to different fields. For example, the method may be applied to a financial field (in the financial field, an affecting factor system that may affect a financial activity may be pre-configured, then after surface activity features of an object for different financial products are obtained, deep mining and analysis processing may be performed on the surface activity features by using a deep mining and analysis model, to obtain factor semantic representation features of the surface activity features for various affecting factors, and then a related policy in the financial field may be formulated for the object based on the deep factor semantic representation features, for example, a recommended financial product or recommended financial information is determined for the object, that is, the present disclosure may be applied to financial product recommendation, financial information recommendation, and the like in the financial field), or a medical field (in the medical field, an affecting factor system that may affect a medical activity may be pre-configured, then after a surface activity feature of an object in the medical field is obtained, deep mining and analysis processing may be performed on the surface activity feature by using a deep mining and analysis model, to obtain a factor semantic representation feature of the surface activity feature for each affecting factor, and then a related policy in the medical field may be formulated for the object based on the deep factor semantic representation feature, for example, medical information or a medical product is recommended for the object, that is, the present disclosure may be applied to medical product recommendation, medical information recommendation, and the like in the medical field). Certainly, the foregoing application field is merely an example for description, and an application field of the method provided in the present disclosure is not limited thereto. For example, the method may be further applied to any decision field, for example, an advertisement recommendation field, which is not described one by one herein by using an example.

In the present disclosure, a configuration affecting factor system of a service may be constructed, and then a service surface activity feature of an object in the service may be converted into a deep factor semantic representation feature by using a deep mining and analysis model. A service policy of the object for the service is determined and outputted based on the deep factor semantic representation feature instead of being determined based on a surface activity feature, thereby better improving accuracy of the service policy. In addition, in the present disclosure, when the service policy is determined and outputted, policy interpretation information for the service policy may be further outputted. A reason for determining the service policy (affected by which deep features) may be well explained by using the policy interpretation information, so that determining logic of the service policy can be presented intuitively, and credibility of the service policy can be improved well. In addition, because the policy interpretation information is determined based on the deep factor semantic representation feature, an interpretation level of the policy interpretation information is also relatively high, so that the credibility of the service policy can be further improved, and related and unique formulation of a final service policy can be facilitated well.

The method provided in the embodiments of the present disclosure may be performed by a computer device, and the computer device includes, but not limited to, a terminal device or a service server. The service server may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform.

The terminal device and the service server may be directly or indirectly connected in a wired or wireless communication manner. This is not limited in the present disclosure.

In some embodiments, the computer device (for example, the service server 1000, the terminal device 100a, or the terminal device 100b) may be one node in a distributed system. The distributed system may be a blockchain system, and the blockchain system may be a distributed system formed by connecting a plurality of nodes in a network communication form. A peer to peer (P2P) network may be formed between nodes. A P2P protocol is an application-layer protocol running over a transmission control protocol (TCP). In the distributed system, computer devices in any form, for example, electronic devices such as a service server and a terminal device, can join the P2P network to become a node in the blockchain system. For ease of understanding, the following describes a concept of a blockchain. The blockchain is a new application mode of computer technologies such as distributed data storage, point-to-point transmission, a consensus mechanism, and an encryption algorithm and is mainly configured to sort data according to a time sequence and encrypt the data to form a ledger, so that the data cannot be tampered and forged, and at the same time, verification, storage, and updating can be performed on the data. When a computer device is a blockchain node, because of a tamper-proof feature and an anti-counterfeiting feature of a blockchain, data (for example, a surface activity feature of a user) in the present disclosure has authenticity and security, so that a result obtained by performing related data processing based on the data can be more reliable.

In a specific implementation of the present disclosure, related data such as user information and user data (for example, data such as an operation performed by a user and a surface activity feature of the user) is obtained after being authorized by the user (namely, with consent of the user). In other words, when the foregoing embodiments of the present disclosure are applied to a specific product or technology, a method and a related function (for example, a recommendation function) provided in the embodiments of the present disclosure run with permission or consent of the user (a function provided in the embodiments of the present disclosure may be actively enabled by the user), and collection, use, and processing of related data need to comply with related laws and regulations and standards in a related country and region.

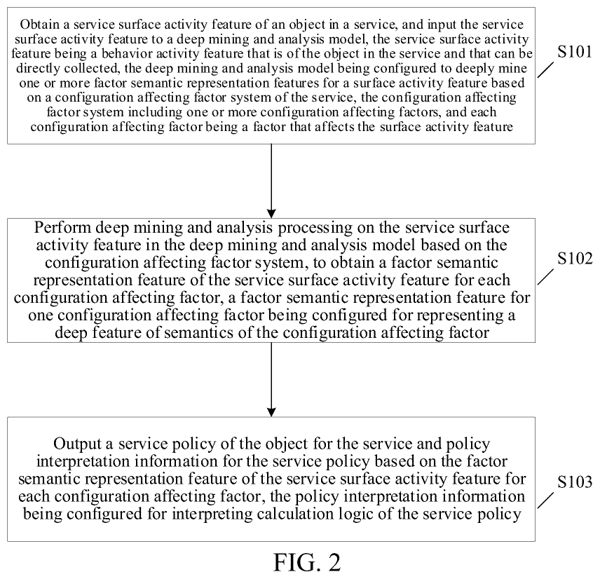

Further, for ease of understanding, FIG. 2 is a schematic flowchart of a data processing method according to an embodiment of the present disclosure. The method provided in this embodiment of the present disclosure may be applied to various scenarios, including, but not limited to, a cloud technology, artificial intelligence, smart transport, assisted driving, and the like. The method may be performed by a computer device, the computer device may be a terminal device (for example, any terminal device in the terminal device cluster shown in FIG. 1, for example, the terminal device 100a), the computer device may be a service server (for example, the service server 1000 in the embodiment corresponding to FIG. 1), or the computer device may be the terminal device and the service server. As shown in FIG. 2, the data processing method may include at least the following operation S101 to operation S103.

Operation S101: Obtain a service surface activity feature of an object in a service, and input the service surface activity feature to a deep mining and analysis model, the service surface activity feature being a behavior activity feature of the object directly corrected in the service, the deep mining and analysis model being configured to deeply mine one or more factor semantic representation features for a surface activity feature based on a configuration affecting factor system of the service, the configuration affecting factor system including one or more configuration affecting factors that affect the surface activity feature.

In the present disclosure, the service may be a service configured for providing a function for a user in an application field. For example, the service may be a financial information recommendation service (configured for providing a financial information recommendation function for a user), a financial product recommendation service (configured for providing a financial product recommendation function for the user), a keyword search and query guidance service (which may be understood as a search and query suggestion service, and configured for providing a guidance function for the user), or an associated product presentation service (configured for presenting a product associated with an item to the user) in a financial field. The service may alternatively be a medical suggestion service (configured for providing a medical suggestion function for a user), a medical product recommendation service (configured for providing a medical product recommendation function for the user), or the like in a medical field. The service may alternatively be a food matching recommendation service (configured for providing a food matching suggestion function for a user), or the like in a health field. The application fields and the services in the application fields are merely described by way of examples. The application fields and the services in the application fields in the present disclosure are certainly not limited thereto. For example, the application field may alternatively be an insurance field or a multimedia field, and the service may be an insurance item recommendation service in the insurance field, an advertisement recommendation service in the multimedia field, or the like, which is not described one by one herein by using an example.

In different services, different objects (for example, users) generate different behaviors. In the present disclosure, a behavior generated by an object in a service may be understood as a behavior activity of the object in the service, and the behavior activity can be intuitively observed or directly collected and obtained. In this case, the behavior activity may be understood as an appearance behavior activity (or a surface behavior activity) of the object in the service. Based on this, in the present disclosure, the appearance behavior activity (or the surface behavior activity) of the object in the service is referred to as a surface activity feature. In other words, the surface activity feature of the object in the service may be a behavior activity feature that floats on a surface and that can be observed by the object in the service. The surface activity feature is configured for describing a surface phenomenon that can be observed by the object in the service. An example in which the service is a shopping service is used, behavior activities such as browsing duration of different items (commodities), browsing frequencies of different items (commodities), a click-through rate of an advertisement carrying an item, collection rates of different items, and purchase frequencies of different items of the object in the shopping service can all be observed or directly collected, and these behavior activities can all be used as surface activity features of the object in the shopping service.

It can be learned from the above that, the surface activity feature is a behavior activity feature that is configured for describing only a surface phenomenon. To some extent, a feature level of the surface activity feature is a surface level, and the surface activity feature cannot accurately represent an essential rule in the service. Based on this, in the present disclosure, after the surface activity feature of the object in the service is obtained, deep mining and analysis processing may be performed on the surface activity feature, to obtain a deep feature corresponding to the surface activity feature. Deep mining and analysis processing in the present disclosure may refer to a processing process of analyzing a reason for generating the surface activity feature. Because the reason for generating the surface activity feature is unobservable deep content, the reason for generating the surface activity feature may be referred to as the deep feature corresponding to the surface activity feature. A surface behavior activity of an object may be affected by a plurality of factors (in the present disclosure, a factor that affects the surface behavior activity may be referred to as an affecting factor, and one affecting factor may be understood as a reason for generating the surface behavior activity). The deep feature herein may be a feature configured for reflecting semantics of different affecting factors. In other words, the deep feature is a deep feature that affects the surface behavior activity of the object, and one surface activity feature may correspond to a plurality of deep features (one surface activity feature may be affected by a plurality of affecting factors, and one surface activity feature may be affected by a plurality of deep features). One deep feature may alternatively be reflected on a plurality of surface activity features (that is, the same deep feature may generate different behavior activities). An example in which the service is a shopping service is used. Assuming that a surface activity feature of an object is “a click-through rate of an advertisement page of a commodity with a very high price is very high”, an affecting factor causing the surface behavior activity may include a virtual resource status factor (for example, a virtual resource of the object is sufficient), a commodity type matching factor (for example, a commodity type of the commodity satisfies a purchasing preference of the object), a commodity quality factor (for example, quality of the commodity is relatively good), and the like. In the present disclosure, a deep feature (which may be understood as a factor semantic representation feature, and the factor semantic representation feature represents semantics of an affecting factor) representing factor semantics of each affecting factor may be generated.

In other words, in the present disclosure, a surface feature (for example, a surface activity feature) is a feature that is configured for describing a surface phenomenon. To learn an essential rule of a service from the surface phenomenon, in the present disclosure, deep mining processing may be performed on the surface activity feature, to determine a factor (namely, an affecting factor) that affects the surface activity feature, and further obtain a deep feature (referred to as a factor semantic representation feature) that represents the affecting factor. In this way, the essence of the service can be accurately reflected based on the factor semantic representation feature of the surface activity feature. Specifically, for a surface activity feature of each object, in the present disclosure, deep mining processing may be performed on the surface activity feature by using a deep mining and analysis model, to obtain a deep feature that represents the surface activity feature. To improve performance of the deep mining and analysis model for analyzing the essence by using the surface activity feature, in the present disclosure, an affecting factor system may be pre-constructed for different services, for example, in the present disclosure, factors that may affect a surface behavior activity in a service may be pre-configured for different services in a manual or semi-automatic manner, to obtain a configuration affecting factor system. Subsequently, deep mining and analysis processing may be performed on the surface activity feature in the deep mining and analysis model based on the configuration affecting factor system, to obtain a factor semantic representation feature (one factor semantic representation feature represents semantics of one configuration affecting factor) of the surface activity feature for each configuration affecting factor.

In other words, the configuration affecting factor system in the present disclosure may be pre-configured in a manual or semi-automatic manner. Because in different service scenarios, factors that affect a surface behavior activity of an object may be different, configuration affecting factor systems of different services are also different. In other words, the configuration affecting factor system varies with different services, and each configuration affecting factor system is configured for completely describing factors that affect a surface behavior activity in a service. An example in which an application field is a financial field is used, and for a financial product recommendation service in the financial field, a factor that affects a surface behavior activity in the financial product recommendation service may include a virtual resource status factor of an object, an investment preference factor of the object for a financial product, a type preference factor of the object for a financial product, an activity time rule factor, a macro-environment factor, and the like. These factors may all be used as configuration affecting factors of the financial product recommendation service, and a configuration affecting factor system of the financial product recommendation service may include these configuration affecting factors.

To improve accuracy of the factor semantic representation feature outputted by using the deep mining and analysis model, in the present disclosure, the deep mining and analysis model may be trained and optimized. For a process of training and optimizing the deep mining and analysis model, the deep mining and analysis model may be trained and optimized in a machine learning (for example, deep learning) manner. For a specific manner of training and optimizing the deep mining and analysis model, refer to related descriptions in subsequent embodiments.

Operation S102: Perform deep mining and analysis processing on the service surface activity feature in the deep mining and analysis model based on the configuration affecting factor system, to obtain a factor semantic representation feature of the service surface activity feature for each configuration affecting factor, a factor semantic representation feature for one configuration affecting factor representing a deep feature of semantics of the configuration affecting factor.

In the present disclosure, it can be learned from the above that the surface activity feature of the object in the service may be referred to as the service surface activity feature. The service surface activity feature of the object may include surface behavior activities generated under the impact of different affecting factors. In this case, deep mining and analysis processing (namely, processing in which an affecting factor of the service surface activity feature is analyzed and a deep feature of semantics of the affecting factor is determined) may be performed on the service surface activity feature in the deep mining and analysis model based on the configuration affecting factor system, to mine affecting factors of the service surface activity feature, so as to generate a factor semantic representation feature that represents each factor. In other words, the factor semantic representation feature finally outputted by using the deep mining and analysis model may include a factor semantic representation feature corresponding to each configuration affecting factor (one factor semantic representation feature represents semantics of one configuration affecting factor). The configuration affecting factors included in the configuration affecting factor system are pre-configured factors that may affect behavior activities of different objects in a service. Actually, not all configuration affecting factors affect a behavior activity of an object in the service. Therefore, for a service surface activity feature of the object, configuration affecting factors that actually affect the service surface activity feature may be only some factors in the configuration affecting factor system (that is, some configuration affecting factors may not affect or cause very little impact on the service surface activity feature). In this case, these configuration affecting factors that cause no impact or cause little impact may be understood as invalid configuration affecting factors of the service surface activity feature. Therefore, because the invalid configuration affecting factors do not affect the service surface activity feature (or cause little impact on the service surface activity feature), in factor semantic representation features outputted by performing deep mining and analysis by using the deep mining and analysis model, factor semantic representation features for these invalid configuration affecting factors may be invalid values (for example, the deep mining and analysis model outputs null values). In other words, deep mining and analysis processing is performed on the service surface activity feature by using the deep mining and analysis model, to obtain, through analysis, factors that affect the service surface activity feature in the configuration affecting factor system. Subsequently, deep features (factor semantic representation features) that represent semantics of the configuration affecting factors may be generated. For factors that do not affect the service surface activity feature, the deep mining and analysis model may output null values. The factors that affect the service surface activity feature may be determined by using an output result of the deep mining and analysis model (when the deep mining and analysis model outputs a factor semantic representation feature, a configuration affecting factor is a factor that affects the service surface activity feature, and when the deep mining and analysis model outputs a null value, the configuration affecting factor is a factor that does not affect or cause little impact on the service surface activity feature).

For ease of understanding a specific manner of performing deep mining and analysis processing on the service surface activity feature in the deep mining and analysis model, to obtain the factor semantic representation feature of the service surface activity feature for each configuration affecting factor, the following describes, by using an example in which the service is an item recommendation service (an item recommendation service in a shopping field) and a configuration affecting factor includes a virtual resource status factor, a specific manner of performing deep mining and analysis processing on the service surface activity feature in the deep mining and analysis model based on the configuration affecting factor system, to obtain the factor semantic representation feature of the service surface activity feature for each configuration affecting factor. The specific manner may be: A virtual resource activity feature of the object associated with the virtual resource status factor may be obtained in the service surface activity feature. The virtual resource activity feature may include regional information of the object and an exchange frequency of the object for a target type item. The target type item is an item having an attribute value greater than a threshold. Subsequently, determining may be performed based on the virtual resource activity feature, for example, a virtual resource status of the object may be determined as a sufficient state when a region type to which the regional information belongs is a high-quality region type and the exchange frequency is greater than a frequency threshold, a first factor semantic representation feature configured for reflecting the sufficient state is generated, and the first factor semantic representation feature is determined as a factor semantic representation feature of the service surface activity feature for the virtual resource status factor. A virtual resource status of the object may be determined as a deficient state when a region type to which the regional information belongs is a common region type or the exchange frequency is less than a frequency threshold, a second factor semantic representation feature configured for reflecting the deficient state is generated, and the second factor semantic representation feature is determined as a factor semantic representation feature of the service surface activity feature for the virtual resource status factor.

The virtual resource status may be understood as a status of a total quantity of virtual resources owned by the object. If a total quantity of virtual resources owned by an object is relatively large, a virtual resource status of the object may be determined as a resource-sufficient state, so that the object is likely to purchase a relatively large quantity of items in the shopping field, and is also likely to purchase a relatively expensive item (namely, an item with an attribute value greater than a threshold, which is referred to as a target type item in the present disclosure) in the shopping field. In addition, when an object has sufficient virtual resources, an activity region of the object may also be in a relatively high-quality region (that is, a region type to which the object belongs is a high-quality region type. In the present disclosure, regions of objects may be classified based on types, for example, a type of a region with relatively poor activity and low consumption and at a relatively remote location may be classified into a common region type, and a type of a region with relatively high activity and high consumption and at a location relatively close to a central region may be classified into a high-quality region type, and a specific region type classification method may be determined based on an actual situation, which is not limited herein). In this case, after a service surface activity feature is obtained, if it is expected to determine whether the virtual resource status factor affects the service surface activity feature, in this case, whether these behavior features generated under the impact of the virtual resource status factor exist in the service surface activity features may be queried, that is, whether virtual resource activity features, that is, regional information of the object, an exchange frequency of the object for the target type item (the exchange frequency may be understood as a frequency of exchanging the target type item by using a virtual resource, that is, a frequency of purchasing the target type item), and the like, exist in the service surface activity feature is queried, and it may be determined whether a virtual resource status of the object is a sufficient state or a deficient state based on the virtual resource activity features (when a total quantity of virtual resources owned by an object is relatively small, it may be determined that a virtual resource status of the object is a resource-deficient state).

Further, after the virtual resource status of the object is determined, a deep feature configured for reflecting the virtual resource status of the object may be generated, and the deep feature may be used as the factor semantic representation feature for the virtual resource status factor of the object. For example, when the virtual resource status of the object is a resource-sufficient state (or referred to as a sufficient state), a deep feature configured for reflecting the sufficient state may be generated as a factor semantic representation feature for the virtual resource status factor of the object. When the virtual resource status of the object is a resource-deficient state (or referred to as a deficient state), a deep feature configured for reflecting the deficient state may be generated as a factor semantic representation feature for the virtual resource status factor of the object.

The resource-sufficient state and the resource-deficient state each may be used as a factor category of the virtual resource status factor, and different configuration affecting factors may have different factor categories. An example in which a configuration affecting factor is a macro-environment is used, and the macro-environment may specifically include two states: a good environment and a poor environment. In this case, for the configuration affecting factor of the macro-environment, factor categories thereof are “good environment” and “poor environment”, and the factor categories of the macro-environment are not consistent with the factor categories of the virtual resource status factor. In other words, a factor category of a configuration affecting factor is derived based on the configuration affecting factor, and factor categories of different configuration affecting factors may be inconsistent.

The foregoing is an example for ease of understanding the manner of performing deep mining and analysis processing on the service surface activity feature, and is not intended to limit that the virtual resource activity feature includes only the regional information of the object and the exchange frequency for the target type item, and is not intended to limit that the configuration affecting factor includes the virtual resource status factor. The configuration affecting factor system of the service may be actually determined through manual experience, and an activity feature of a configuration affecting factor system is actually flexibly determined and is not limited in the present disclosure.

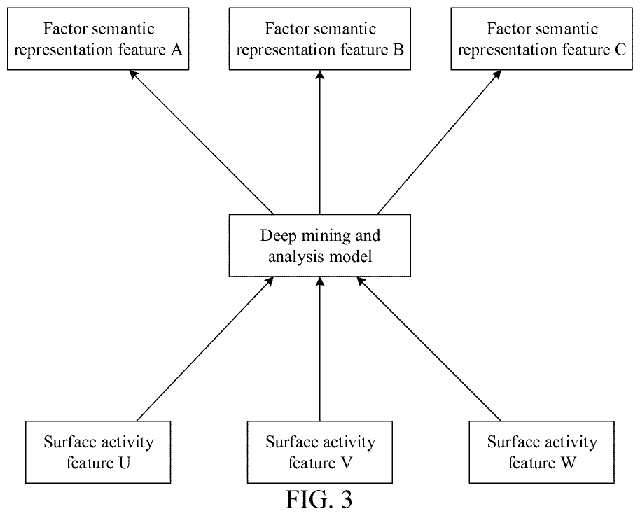

It can be learned from the above that a surface activity feature may be affected by a plurality of configuration affecting factors, that is, the surface activity feature may correspond to different factor semantic representation features, and the surface activity feature includes different types of activity features (for example, the virtual resource activity feature). Some features in the surface activity feature may be affected by a configuration affecting factor A, and some features may be affected by a configuration affecting factor B. In other words, different factor semantic representation features may be obtained through mining and analysis based on different activity features in the surface activity feature. For ease of understanding, FIG. 3 is a schematic diagram of a correspondence between a surface activity feature and a factor semantic representation feature according to an embodiment of the present disclosure. As shown in FIG. 3, it is assumed that a service surface activity feature includes a surface activity feature U, a surface activity feature V, and a surface activity feature W. After the surface activity feature U, the surface activity feature V, and the surface activity feature W are inputted to a deep mining and analysis model, a factor semantic representation feature A corresponding to the surface activity feature U, a factor semantic representation feature B corresponding to the surface activity feature V, and a factor semantic representation feature C corresponding to the surface activity feature W may be outputted by using the deep mining and analysis model. In other words, different factor semantic representation features may be obtained through mining and analysis based on different activity features in the surface activity feature.

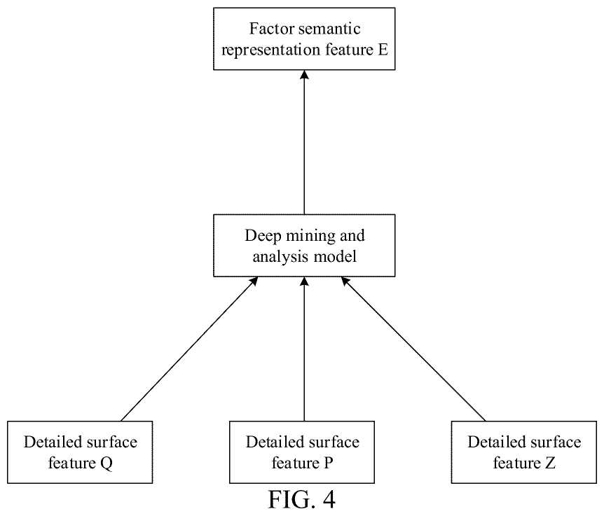

In the service surface activity feature, an activity feature of the same type may include different content (for example, the virtual resource activity feature may include the regional information of the object and may further include the exchange frequency of the object for the target type item). In the present disclosure, the content may also be used as components (more detailed components) of the service surface activity feature, that is, the content may also be referred to as surface activity features (actually, detailed surface features in the service surface activity feature). In this case, a plurality of detailed surface features may be affected by the same affecting factor. It can be learned that the plurality of detailed surface features may correspond to the same factor semantic representation feature. For ease of understanding a correspondence between the detailed surface feature and the factor semantic representation feature, refer to FIG. 4. FIG. 4 is a schematic diagram of a correspondence between a detailed surface feature and a factor semantic representation feature according to an embodiment of the present disclosure. As shown in FIG. 4, it is assumed that a service surface activity feature includes a surface activity feature R, a surface activity feature O, and a surface activity feature X, and the surface activity feature R includes a detailed surface feature Q, a detailed surface feature P, and a detailed surface feature Z. After the detailed surface feature Q, the detailed surface feature P, and the detailed surface feature Z are inputted to a deep mining and analysis model, a factor semantic representation feature E corresponding to the detailed surface feature Q, the detailed surface feature P, and the detailed surface feature Z may be outputted by using the deep mining and analysis model. In other words, the same factor semantic representation feature may be obtained through mining and analysis based on different detailed surface features in the surface activity feature.

It can be learned from the above that the service surface activity feature may be affected by different configuration affecting factors, and then a factor semantic representation feature corresponding to the service surface activity feature reflects semantics of different configuration affecting factors, that is, semantics represented by different factor semantic representation features is different. To improve a difference between factor semantic representation features to enable a factor semantic representation feature to independently reflect semantics of a configuration affecting factor more accurately, in the present disclosure, semantic constraint may be performed on factor semantic representation features outputted by using the deep mining and analysis model. Subsequently, each factor semantic representation feature on which semantic constraint is performed is used as a final factor semantic representation feature of the service surface activity feature. Specifically, representation features outputted by using the deep mining and analysis model may be used as initial factor semantic representation features. Subsequently, semantic constraint processing may be performed on each initial factor semantic representation feature, to obtain a final factor semantic representation feature.

In other words, an example in which the configuration affecting factor system includes a configuration affecting factor Sᵢ (i is a positive integer) is used. A specific manner of performing deep mining and analysis processing on the service surface activity feature in the deep mining and analysis model based on the configuration affecting factor system, to obtain the factor semantic representation feature of the service surface activity feature for each configuration affecting factor may be: Deep mining and analysis processing may be performed on the service surface activity feature in the deep mining and analysis model based on the configuration affecting factor system. In this way, an initial factor semantic representation feature of the service surface activity feature for each configuration affecting factor may be outputted. Further, for the configuration affecting factor Si, configuration affecting factors other than the configuration affecting factor Si in the configuration affecting factor system may be determined as remaining configuration affecting factors (that is, any configuration affecting factor other than the configuration affecting factor Sᵢ in the configuration affecting factor system may be referred to as a remaining configuration affecting factor), and semantic constraint processing may be performed on an initial factor semantic representation feature of the service surface activity feature for the configuration affecting factor Si according to an initial factor semantic representation feature of the service surface activity feature for each of the remaining configuration affecting factors. In this way, a factor semantic representation feature of the service surface activity feature for the configuration affecting factor Sᵢ may be obtained. The factor semantic representation feature of the service surface activity feature for each configuration affecting factor may be obtained in the manner of obtaining the factor semantic representation feature of the service surface activity feature for the configuration affecting factor Sᵢ. Semantic constraint processing in the present disclosure may refer to processing in which a factor semantic representation feature for a configuration affecting factor is continuously optimized through comparison between the factor semantic representation feature for the configuration affecting factor and a factor semantic representation feature for another configuration affecting factor in a comparison learning manner, to enable the factor semantic representation feature for the configuration affecting factor to more effectively reflect semantics of the configuration affecting factor. Therefore, effectiveness and accuracy of the factor semantic representation feature for each configuration affecting factor can be improved through semantic constraint processing. The configuration affecting factor Sᵢ is used as an example, and semantic constraint processing is performed on the factor semantic representation feature for the configuration affecting factor Sᵢ. In other words, initial factor semantic representation features for the remaining configuration affecting factors are compared with the initial factor semantic representation feature for the configuration affecting factor Sᵢ, and then the initial factor semantic representation feature for the configuration affecting factor Sᵢ is optimized by using a comparison result, to obtain the factor semantic representation feature with relatively high effectiveness for the configuration affecting factor Sᵢ.

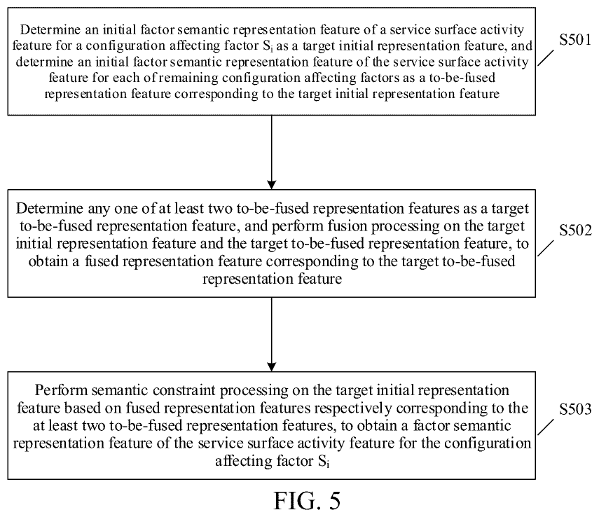

For a specific implementation of performing semantic constraint processing on the initial factor semantic representation feature of the service surface activity feature for the configuration affecting factor Sᵢ according to the initial factor semantic representation feature of the service surface activity feature for each of the remaining configuration affecting factors, to obtain the factor semantic representation feature of the service surface activity feature for the configuration affecting factor Sᵢ, refer to descriptions in a subsequent embodiment corresponding to FIG. 5.

Operation S103: Output a service policy of the object for the service and policy interpretation information for the service policy based on the factor semantic representation feature of the service surface activity feature for each configuration affecting factor, wherein the policy interpretation information interprets a calculation logic of the service policy.

In the present disclosure, after the factor semantic representation feature of the service surface activity feature is determined, the deep factor semantic representation feature may be inputted to a service policy model of the service, and the deep factor semantic representation feature may be calculated and analyzed by using the service policy model, to obtain the service policy of the object in the service. In addition, to improve credibility of the service policy, the policy interpretation information for the service policy may be further outputted. The policy interpretation information is configured for interpreting the calculation logic of the service policy (namely, obtaining reasoning logic of the service policy), to interpret a reason for outputting the service policy. Therefore, the service policy can have interpretability, and the policy interpretation information for the service policy is configured for performing interpretation based on the deep factor semantic representation feature, which has relatively high accuracy.

The service policy varies with different services, for example, when the service is an item recommendation service, the service policy may be an item policy recommended to the object (that is, an output result is a recommended item for the object). When the service is an information pushing service, the service policy may be information recommended to the object (that is, an output result is recommended information for the object). In other words, the service policy may have different forms based on the service. An example in which the service is a media data recommendation service is used, the service policy is recommended media data for the object, and the policy interpretation information may be recommendation interpretation information for the recommended media data. In this case, a specific implementation of outputting the service policy of the object for the service and the policy interpretation information for the service policy based on the factor semantic representation feature of the service surface activity feature for each configuration affecting factor may be: A set formed by the factor semantic representation feature of the service surface activity feature for each configuration affecting factor may be determined as a factor semantic representation feature set. Subsequently, the factor semantic representation feature set may be inputted to a media data recommendation model. The media data recommendation model is obtained by training and optimizing a sample media data recommendation model based on a sample factor semantic representation feature set of a sample object in the media data recommendation service. The sample factor semantic representation feature set includes a sample factor semantic representation feature of a sample service surface activity feature for each configuration affecting factor. The sample service surface activity feature is a surface activity feature of the sample object in the media data recommendation model. Recommended media data corresponding to the factor semantic representation feature set may be outputted by using the media data recommendation model. Recommendation interpretation information for the recommended media data may be determined based on a model attribute of the media data recommendation model.

To improve performance of the media data recommendation model, in the present disclosure, the sample factor semantic representation feature set of the sample object may be obtained in advance (the sample service surface activity feature of the sample object is first obtained, and then deep mining and analysis processing is performed on the sample service surface activity feature by using a deep mining and analysis model, to obtain the sample factor semantic representation feature of the sample service surface activity feature for each configuration affecting factor), then the sample media data recommendation model may be trained and optimized based on the sample factor semantic representation feature set (formed by the sample factor semantic representation feature of the sample service surface activity feature for each configuration affecting factor). Specifically, any neural network model (a model with interpretability or a model without interpretability, where the model with interpretability has interpretability and can interpret calculation logic of an output result of the model, and the model without interpretability does not have interpretability and does not interpret calculation logic of an output result of the model, and the outside world cannot learn a calculation process of the model) may be used as the sample media data recommendation mode. For a training and optimization process of the model, a suitable model training and optimization manner may be used (for example, a label training manner or a reinforcement learning training manner is used). A specific model training and optimization process is not described herein.

The model with interpretability has interpretability, and the policy interpretation information for the service policy may be directly outputted by using the model with interpretability. The model without interpretability does not have interpretability. Therefore, when the media data recommendation model is the model without interpretability, an additional interpretable model (namely, a model having a calculation logic output function, that is, the model with interpretability) needs to be used to interpret the service policy, for example, a global surrogate model, a local interpretable model-agnostic explanations (LIME) model, or a shapley additive explanations (SHAP) model may be used. In other words, when the media data recommendation model is the model without interpretability, the policy interpretation information may be outputted by using the interpretable model. Because the media data recommendation model may include the model without interpretability and the model with interpretability, in the present disclosure, a corresponding model attribute may be configured for the media data recommendation model based on the model without interpretability and the model with interpretability, for example, a model attribute of the model without interpretability may be a black-box attribute, and a model attribute of the model with interpretability may be a white-box attribute. It can be learned based on this that, in the present disclosure, the model attribute of the media data recommendation model may include the black-box attribute and the white-box attribute. Therefore, when the model attribute of the media data recommendation model is the black-box attribute, a specific implementation of determining the recommendation interpretation information for the recommended media data based on the model attribute of the media data recommendation model may be: An interpretable model (for example, a SHAP model) configured to perform result interpretation on a model result outputted by the media data recommendation model may be obtained. Subsequently, the factor semantic representation feature set and the recommended media data may be jointly inputted to the interpretable model, and a feature impact value corresponding to each factor semantic representation feature in the factor semantic representation feature set may be outputted by using the interpretable model. In this way, a feature impact value set may be obtained. One feature impact value in the feature impact value set represents an impact degree of a corresponding factor semantic representation feature on the recommended media data. The recommendation interpretation information for the recommended media data may be generated based on the feature impact value set.

A specific implementation of generating the recommendation interpretation information for the recommended media data based on the feature impact value set may be: Each feature impact value may be sorted according to a magnitude of each feature impact value in the feature impact value set, to obtain an impact value sequence. Subsequently, factor semantic representation features respectively corresponding to the first K (K may be a positive integer, K may be set based on manual experience, and a value of K is usually greater than 1) feature impact values in the impact value sequence may be determined as high-impact representation features. The recommendation interpretation information for the recommended media data may be generated based on factor semantics reflected by the high-impact representation features.

Through the interpretable model, that a factor semantic representation feature in the factor semantic representation feature set has the most impact on a model result (namely, the service policy), that is, result interpretation is performed on the service policy. The result interpretation herein is configured for interpreting importance (namely, an impact degree) of each model input on a model output, for example, the interpretable model may be a shapley additive explanation (SHAP) model, and a contribution (namely, the impact degree) of each model input to a model output may be outputted by using the interpretable model. In the present disclosure, an impact value (which may be referred to as a feature impact value, configured for representing an impact degree of a corresponding factor semantic representation feature on an output result of the model, where a larger feature impact value may represent a higher impact degree of a corresponding factor semantic representation feature on the output result of the model, for example, a feature impact value corresponding to a factor semantic representation feature 1 is 30, and a feature impact value corresponding to a factor semantic representation feature 2 is 20, in this case, a higher impact degree of the factor semantic representation feature 1 on the output result of the model may be determined by using the two feature impact values) corresponding to each factor semantic representation feature may be outputted by using the interpretable model. Based on this, each feature impact value may be sorted according to a magnitude (usually in descending order) of each feature impact value in the feature impact value set, to obtain an impact value sequence, and factor semantic representation features respectively corresponding to the first K (K may be a positive integer, K may be a value preset based on manual experience, and K is usually greater than 1) feature impact values may be determined as most-impact representation features (or high-impact representation features). A larger feature impact value may indicate a higher impact degree of a factor semantic representation feature on the output result (the service policy) of the model.

Further, if each feature impact value is sorted in ascending order, the last K feature impact values in the impact value sequence may be obtained, and factor semantic representation features respectively corresponding to the last K feature impact values may be most-impact representation features (or high-impact representation features).

Subsequently, the recommendation interpretation information for the recommended media data may be determined by using the high-impact representation features. For example, if a factor category reflected by a high-impact representation feature is “virtual resources are sufficient”, the policy interpretation information may include information “virtual resources of the object are sufficient”. In other words, the policy interpretation information may include factor semantics reflected by the high-impact representation feature.

Regardless of whether a white-box model or a black-box model is used as the media data recommendation model, because an input feature of the media data recommendation model is a deep factor semantic representation feature, an output result (a service policy) of the media data recommendation model is obtained through calculation based on the deep feature, so that the output result of the media data recommendation model is more accurate. In addition, in terms of interpretability of the output result of the media data recommendation model, the output result is essentially interpreted based on the deep factor semantic representation feature instead of being interpreted based on a surface phenomenon of the service. It is clear that credibility of the deep and essential interpretation is higher than that of the interpretation based on the surface phenomenon, so that credibility of the output result of the media data recommendation model can be improved.

In one embodiment of in the present disclosure, in the present disclosure, a configuration affecting factor system of a service may be constructed, then a service surface activity feature of an object in the service may be converted into a deep factor semantic representation feature by using a deep mining and analysis model, and the deep factor semantic representation feature outputted by using the deep mining and analysis model may be optimized through semantic constraint processing between different configuration affecting factors, so that the deep factor semantic representation feature can reflect semantics of the configuration affecting factor more effectively, and the optimized factor semantic representation feature is more accurate and reasonable. Based on this, a service policy of the object for the service is determined and outputted based on the deep factor semantic representation feature with enough accuracy instead of being determined based on a surface activity feature, thereby better improving accuracy of the service policy. In addition, in the present disclosure, when the service policy is determined and outputted, policy interpretation information for the service policy may be further outputted. A reason for formulating the service policy may be well explained by using the policy interpretation information, so that determining logic of the service policy can be presented intuitively, and credibility of the service policy can be improved well. In addition, because the policy interpretation information is determined based on the deep factor semantic representation feature with enough accuracy, an interpretation level of the policy interpretation information is also relatively high, thereby further improving the credibility of the service policy. Based on the foregoing, in the present disclosure, in a task of determining a service policy, credibility of the determined service policy can be improved.

Further, FIG. 5 is a schematic flowchart of performing semantic constraint processing on a factor semantic representation feature according to an embodiment of the present disclosure. The process may correspond to the process of performing semantic constraint processing on the initial factor semantic representation feature of the service surface activity feature for the configuration affecting factor Si according to the initial factor semantic representation features of the service surface activity feature for the remaining configuration affecting factors, to obtain the factor semantic representation feature of the service surface activity feature for the configuration affecting factor Si in the foregoing embodiment corresponding to FIG. 2, and the process is described by using an example in which there are at least two remaining configuration affecting factors. As shown in FIG. 5, the process may include at least the following operation S501 to operation S503.

Operation S501: Determine the initial factor semantic representation feature of the service surface activity feature for the configuration affecting factor Sᵢ as a target initial representation feature, and determine an initial factor semantic representation feature of the service surface activity feature for each of the remaining configuration affecting factors as a to-be-fused representation feature corresponding to the target initial representation feature.

Specifically, for ease of distinguishing, the initial factor semantic representation feature that is for the configuration affecting factor Si and that is outputted by using the deep mining and analysis model may be used as the target initial representation feature, and the initial factor semantic representation feature that is for each of the remaining configuration affecting factors and that is outputted by using the deep mining and analysis model may be used as the to-be-fused representation feature corresponding to the target initial representation feature, so that the at least two remaining configuration affecting factors correspond to at least two to-be-fused representation features.

Operation S502: Determine any one of the at least two to-be-fused representation features as a target to-be-fused representation feature, and perform fusion processing on the target initial representation feature and the target to-be-fused representation feature, to obtain a fused representation feature corresponding to the target to-be-fused representation feature.

Specifically, fusion processing may be performed on any to-be-fused representation feature and the target initial representation feature, to obtain a fused representation feature. For ease of description, any to-be-fused representation feature may be referred to as the target to-be-fused representation feature. In this case, fusion processing is performed on the target to-be-fused representation feature and the target initial representation feature, to obtain the fused representation feature corresponding to the target to-be-fused representation feature. The fusion processing herein may refer to fusion processing in any form, for example, may refer to concatenation processing or addition calculation processing. Each to-be-fused representation feature may be fused with the target initial representation feature, to obtain a fused representation feature corresponding to a to-be-fused representation feature.

Operation S503: Perform semantic constraint processing on the target initial representation feature based on fused representation features respectively corresponding to the at least two to-be-fused representation features, to obtain the factor semantic representation feature of the service surface activity feature for the configuration affecting factor Sᵢ.

Specifically, after the fused representation features respectively corresponding to the at least two to-be-fused representation features are determined, a specific implementation of performing semantic constraint processing on the target initial representation feature based on the fused representation features respectively corresponding to the at least two to-be-fused representation features, to obtain the factor semantic representation feature of the service surface activity feature for the configuration affecting factor Sᵢ may be: A to-be-clustered object set may be obtained. The to-be-clustered object set may include at least two to-be-clustered objects (for example, may include at least two users). Subsequently, clustering processing may be performed on the at least two to-be-clustered objects based on the target initial representation feature, to obtain a first class cluster distribution result. The first class cluster distribution result includes a first class cluster and a second class cluster. A class cluster category to which the first class cluster belongs is a first factor category derived based on the configuration affecting factor Sᵢ. A class cluster category to which the second class cluster belongs is a second factor category derived based on the configuration affecting factor Sᵢ. The first factor category is different from the second factor category. Further, any one of at least two fused representation features may be determined as a target fused representation feature, and clustering processing is performed on the at least two to-be-clustered objects based on the target fused representation feature, to obtain a second class cluster distribution result. The second class cluster distribution result includes a third class cluster and a fourth class cluster. A class cluster category to which the third class cluster belongs is the first factor category. A class cluster category to which the fourth class cluster belongs is the second factor category. A feature distinguishing attribute of the target initial representation feature for the target fused representation feature may be determined according to the first class cluster, the second class cluster, the third class cluster, and the fourth class cluster. When a feature distinguishing attribute of the target initial representation feature for each fused representation feature is determined, the factor semantic representation feature of the service surface activity feature for the configuration affecting factor Sᵢ may be determined based on each feature distinguishing attribute.

A specific implementation of determining the feature distinguishing attribute of the target initial representation feature for the target fused representation feature according to the first class cluster, the second class cluster, the third class cluster, and the fourth class cluster may be: A real factor category label corresponding to each of the at least two to-be-clustered objects may be obtained. Subsequently, to-be-clustered objects whose real factor category labels are the first factor category may be combined, to obtain a first real label class cluster, and to-be-clustered objects whose real factor category labels are the second factor category may be combined, to obtain a second real label class cluster. A first clustering error corresponding to the target initial representation feature may be determined based on the first class cluster, the second class cluster, the first real label class cluster, and the second real label class cluster. A second clustering error corresponding to the target fused representation feature may be determined based on the third class cluster, the fourth class cluster, the first real label class cluster, and the second real label class cluster. The feature distinguishing attribute of the target initial representation feature for the target fused representation feature may be determined as a feature abnormality distinguishing attribute when the first clustering error is greater than the second clustering error and an absolute value of an error difference between the first clustering error and the second clustering error is greater than a difference threshold. The feature distinguishing attribute of the target initial representation feature for the target fused representation feature may be determined as a feature normality distinguishing attribute when the first clustering error is less than the second clustering error or an absolute value of an error difference between the first clustering error and the second clustering error is less than a difference threshold.

To ensure that each obtained factor semantic representation feature can effectively reflect factor semantics of a pre-configured configuration affecting factor, in one embodiment of the present disclosure, semantic constraint may be performed on different factor semantic representation features by using a comparison learning method. Specifically, for an initial factor semantic representation feature (for example, the target initial representation feature), after the target initial representation feature may be fused with each of other initial factor semantic representation features, to obtain fused representation features respectively corresponding to different initial factor semantic representation features, the to-be-clustered object set may be divided through clustering based on each of a fused representation feature and the target initial representation feature. After two division results are obtained, division effects of the two features may be determined based on a real factor category label of each to-be-clustered object in the to-be-clustered object set. For example, the to-be-clustered object set may be divided based on the real factor category label of each to-be-clustered object, to obtain a real division result (including a first real label class cluster and a second real label class cluster), and a clustering error (which may be referred to as a first clustering error, where the division effect of the target initial representation feature may be presented by using the clustering error, for example, if the clustering error is relatively small, it may be represented that the division effect of the target initial representation feature is relatively good) may be determined based on a result (including a first class cluster and a second class cluster) of division based on the target initial representation feature and the real division result. Similarly, a clustering error (for ease of distinguishing, the clustering error may be referred to as a second clustering error, where the division effect of the fused representation feature may also be presented by using the second clustering error) may also be determined based on a result of division on the to-be-clustered object set based on the fused representation feature and the real division result. When the division effects of the target initial representation feature and the fused representation feature have a small difference (that is, when the division effect of the target initial representation feature is only slightly superior to the division effect of the fused representation feature, or the division effect of the target initial representation feature is only slightly inferior to the division effect of the fused representation feature), it may be determined that a division effect obtained by dividing the to-be-clustered object set through clustering based on the target initial representation feature and another initial factor semantic representation feature is approximate to a division effect obtained by dividing the to-be-clustered object set through clustering only based on the target initial representation feature. In other words, for the configuration affecting factor Si, factor category division can be better performed on the to-be-clustered object set based on the target initial representation feature, and the another initial factor semantic representation feature included in the fused representation feature does not play a significant role in a task of dividing the to-be-clustered object set for the configuration affecting factor Sᵢ. In this case, it can be proved that compared with the another initial factor semantic representation included in the fused representation feature, the target initial representation feature can effectively reflect factor semantics of the configuration affecting factor Sᵢ, and the target initial representation feature has enough distinguishability compared with the another initial factor semantic representation feature. Similarly, when the division effect of the target initial representation feature is superior to the division effect of the fused representation feature, it can also be proved that compared with the another initial factor semantic representation feature included in the fused representation feature, the target initial representation feature can effectively reflect the factor semantics of the configuration affecting factor Sᵢ, and the target initial representation feature has enough distinguishability compared with the another initial factor semantic representation feature. When the division effect of the target initial representation feature is much inferior to the division effect of the fused representation feature, it can be proved that in comparison with the target initial representation feature, the to-be-clustered object set can be better divided based on the target initial representation feature and the fused representation feature including the another initial factor semantic representation feature. In this case, it can be proved that compared with the another initial factor semantic representation feature included in the fused representation feature, the target initial representation feature cannot effectively reflect the factor semantics of the configuration affecting factor Sᵢ, the target initial representation feature is compared with the another initial factor semantic representation feature, the another initial factor semantic representation feature may also include related factor semantics of the configuration affecting factor, and the target initial representation feature does not have enough distinguishability compared with the another initial factor semantic representation feature.

In other words, for the target fused representation feature (any fused representation feature), an example in which the configuration affecting factor Sᵢ is the virtual resource status factor is used, the to-be-clustered objects included in the to-be-clustered object set may include a to-be-clustered object with sufficient resources (that is, a virtual resource status is a sufficient state, and a real factor category label is a resource-sufficient label), and may also include a to-be-clustered object with deficient resources (that is, a virtual resource status is a deficient state, and a real factor category label is a resource-deficient label), and the to-be-clustered objects may be classified based on the target initial representation feature. In this way, a first class cluster (a factor category is a first factor category, for example, a resource-sufficient category) and a second class cluster (a factor category is a second factor category, for example, a resource-deficient category) may be obtained. A clustering effect of the target initial representation feature may be determined according to a class cluster distribution result of the target initial representation feature and a real factor category label of the to-be-clustered object set (a clustering error may be obtained, which is referred to as a first clustering error). Similarly, the to-be-clustered objects may alternatively be classified based on the target fused representation feature. In this way, a third class cluster (a factor category is the first factor category, for example, the resource-sufficient category) and a fourth class cluster (a factor category is the second factor category, for example, the resource-deficient category) may be obtained. A clustering effect of the target fused representation feature may be determined according to a class cluster distribution result of the target fused representation feature and the real factor category label of the to-be-clustered object set (a clustering error may be obtained, which is referred to as a second clustering error). It may be determined, based on the first clustering error and the second clustering error, whether objects of the same factor category can be clustered more effectively based on the target initial representation feature for the virtual resource status factor compared with the target fused representation feature. If it is determined that the objects of the same factor category can be clustered more effectively based on the target initial representation feature for the virtual resource status factor (for example, if the first clustering error is less than the second clustering error, or an absolute value of an error difference between the first clustering error and the second clustering error is less than a difference threshold, in this case, it may indicate that the division effect of the target initial representation feature is superior to the division effect of the fused representation feature, or the division effect of the target initial representation feature is slightly superior to (or slightly inferior to) the division effect of the fused representation feature), a feature distinguishing attribute between the target initial representation feature and the target fused representation feature may be determined as a feature normality distinguishing attribute. However, if the objects of the same factor category cannot be clustered effectively based on the target initial representation feature for the virtual resource status factor (for example, if the first clustering error is greater than the second clustering error, and an absolute value of an error difference between the first clustering error and the second clustering error is greater than a difference threshold, it may indicate that the division effect of the target initial representation feature is much inferior to the division effect of the fused representation feature), the feature distinguishing attribute between the target initial representation feature and the target fused representation feature may be determined as a feature abnormality distinguishing attribute.

A specific value of a threshold (for example, the difference threshold) involved in one embodiment of the present disclosure may be a manually pre-configured value, or may be a value determined by a machine through training of a related rule. Usually, the difference threshold is a relatively small value, so that when a result of division based on the target initial representation feature is very close to a result of division based on the fused representation feature, it may be determined that the effects of the target initial representation feature and the fused representation feature have a small difference.

Further, when the feature distinguishing attribute of the target initial representation feature for each fused representation feature is determined, the factor semantic representation feature of the service surface activity feature for the configuration affecting factor Sᵢ may be determined based on each feature distinguishing attribute. A specific implementation thereof may be: A set formed by the feature distinguishing attribute of the target initial representation feature for each fused representation feature may be determined as an attribute set. Further, the attribute set may be traversed. If a feature abnormality distinguishing attribute exists in the attribute set, a feature constraint attribute of the target initial representation feature may be determined as a constraint-deficient attribute (the constraint-deficient attribute reflects that the division effect of the target initial representation feature is much inferior to a division effect of a fused representation feature, and optimization needs to be performed), then the deep mining and analysis model may be optimized based on an absolute value of an error difference, and after an optimized deep mining and analysis model is obtained, deep mining and analysis processing is performed on the service surface activity feature in the optimized deep mining and analysis model based on the configuration affecting factor system. In this way, the factor semantic representation feature of the service surface activity feature for the configuration affecting factor Sᵢ may be obtained. If a feature abnormality distinguishing attribute does not exist in the attribute set, a feature constraint attribute of the target initial representation feature may be determined as a constraint-sufficient attribute (the constraint-sufficient attribute reflects that the division effect of the target initial representation feature is superior to or slightly inferior to a division effect of any fused representation feature, and no optimization is needed), and the target initial representation feature may be directly determined as the factor semantic representation feature of the service surface activity feature for the configuration affecting factor Sᵢ.

In one embodiment of the present disclosure, semantic constraint may be performed on the factor semantic representation feature in a comparison learning manner. In this way, effectiveness and unique representation of the factor semantic representation feature can be better improved, and one factor semantic representation feature can better and effectively reflect one configuration affecting factor.

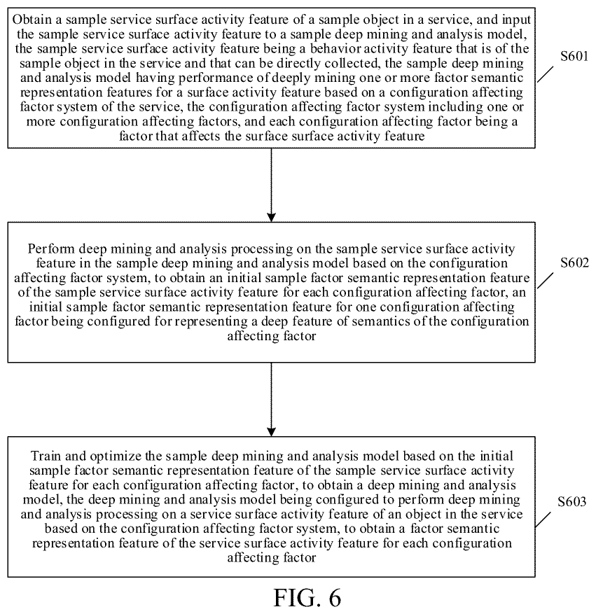

Further, FIG. 6 is a schematic flowchart of another data processing method according to an embodiment of the present disclosure. Specifically, the process may refer to a process of training and optimizing a deep mining and analysis model. The method may be performed by a terminal device (for example, any terminal device in the terminal device cluster shown in FIG. 1, for example, the terminal device 100a), may be performed by the service server (for example, the service server 1000 in the embodiment corresponding to FIG. 1), or may be jointly performed by the terminal device and the service server. For ease of understanding, in one embodiment, an example in which the method is performed by the service server is configured for description. As shown in FIG. 6, the data processing method may include at least the following operation S601 to operation S603.

Operation S601: Obtain a sample service surface activity feature of a sample object in a service, and input the sample service surface activity feature to a sample deep mining and analysis model, the sample service surface activity feature being a behavior activity feature of the sample object directly corrected in the service, the sample deep mining and analysis model being configured to deeply mine one or more factor semantic representation features for a surface activity feature based on a configuration affecting factor system of the service, the configuration affecting factor system including one or more configuration affecting factors that affect the surface activity feature.

Specifically, the sample object may be an object used as a training sample, and the sample service surface activity feature may be a service surface activity feature of the sample object in the service (it can be learned from the above that the service surface activity feature is the behavior activity feature that can be directly observed and collected in the service, and in this case, the service surface activity feature of the sample object in the service is a behavior activity feature that is of the sample object in the service and that can be directly observed and collected. In other words, in the present disclosure, the behavior activity feature that is of the sample object in the service and that can be directly observed and collected is referred to as the sample service surface activity feature). For a manner of obtaining the sample service surface activity feature, refer to the descriptions of obtaining the service surface activity feature of the object in the foregoing embodiment corresponding to FIG. 2. The sample deep mining and analysis model herein may be a deep mining and analysis model before training and optimization.

Operation S602: Perform deep mining and analysis processing on the sample service surface activity feature in the sample deep mining and analysis model based on the configuration affecting factor system, to obtain an initial sample factor semantic representation feature of the sample service surface activity feature for each configuration affecting factor, an initial sample factor semantic representation feature for one configuration affecting factor representing a deep feature of semantics of the configuration affecting factor.

Specifically, for a specific implementation of obtaining the initial sample factor semantic representation feature, refer to the descriptions of performing deep mining and analysis processing on the service surface activity feature in the deep mining and analysis model based on the configuration affecting factor system, to obtain the factor semantic representation feature of the service surface activity feature for each configuration affecting factor in the foregoing embodiment corresponding to FIG. 2. Principles of the two are the same, and details are not described herein again.

Operation S603: Train and optimize the sample deep mining and analysis model based on the initial sample factor semantic representation feature of the sample service surface activity feature for each configuration affecting factor, to obtain a deep mining and analysis model, the deep mining and analysis model being configured to perform deep mining and analysis processing on a service surface activity feature of an object in the service based on the configuration affecting factor system, to obtain a factor semantic representation feature of the service surface activity feature for each configuration affecting factor.

Specifically, an example in which the configuration affecting factor system includes a configuration affecting factor Sᵢ (i is a positive integer) is used, and a specific implementation of training and optimizing the sample deep mining and analysis model, to obtain the deep mining and analysis model may be: An initial sample factor semantic representation feature of the sample service surface activity feature for the configuration affecting factor Sᵢ may be determined as a target initial sample representation feature. Subsequently, semantic constraint processing may be performed on the target initial sample representation feature, to obtain a sample feature constraint attribute corresponding to the target initial sample representation feature. When a sample feature constraint attribute corresponding to each initial sample factor semantic representation feature is determined, a set formed by the sample feature constraint attribute corresponding to each initial sample factor semantic representation feature may be determined as a sample constraint attribute set. If a constraint-deficient attribute exists in the sample constraint attribute set, a model parameter of the sample deep mining and analysis model may be adjusted based on an initial sample factor semantic representation feature corresponding to the constraint-deficient attribute. In this way, an adjusted model parameter may be obtained, and a sample deep mining and analysis model including the adjusted model parameter may be determined as the deep mining and analysis model. If no constraint-deficient attribute exists in the sample constraint attribute set, the sample deep mining and analysis model is determined as the deep mining and analysis model.

In one embodiment of the present disclosure, semantic constraint processing may be performed on the initial sample factor semantic representation features outputted by using the sample deep mining and analysis model, to detect whether each initial sample factor semantic representation feature can effectively and accurately reflect a configuration affecting factor. If it is determined, through semantic constraint processing, that each initial sample factor semantic representation feature can effectively and accurately reflect the configuration affecting factor (that is, there is no initial sample factor semantic representation feature with a constraint-deficient attribute), it may be determined that a result outputted by using the sample deep mining and analysis model has relatively high accuracy, and the model parameter of the model may no longer be adjusted. However, if it is determined, through semantic constraint processing, that some initial sample factor semantic representation features cannot effectively and accurately reflect the configuration affecting factor (that is, there is an initial sample factor semantic representation feature with a constraint-deficient attribute), it may be determined that the result outputted by using the sample deep mining and analysis model does not have relatively high accuracy, and the model parameter of the sample deep mining and analysis model needs to be adjusted until it is determined that each initial sample factor semantic representation feature can effectively and accurately reflect the configuration affecting factor.

For a specific manner of performing semantic constraint processing on the initial sample factor semantic representation feature, refer to the descriptions in the foregoing embodiment corresponding to FIG. 5. Principles are the same, and details are not described herein again. After the sample deep mining and analysis model is trained and optimized in a semantic constraint manner, the obtained deep mining and analysis model has relatively high performance. Therefore, during application, after a factor semantic representation feature of an object is inputted to the deep mining and analysis model, an initial factor semantic representation feature outputted by using the deep mining and analysis model may be directly determined as a final factor semantic representation feature, and no semantic constraint processing needs to be performed.

In one embodiment, a configuration affecting factor system of a service may be constructed, and then a service surface activity feature of an object in the service may be converted into a deep factor semantic representation feature by using a deep mining and analysis model. A service policy of the object for the service is determined and outputted based on the deep factor semantic representation feature instead of being determined based on a surface activity feature, thereby better improving accuracy of the service policy. In addition, in the present disclosure, when the service policy is determined and outputted, policy interpretation information for the service policy may be further outputted. A reason for determining the service policy may be well explained by using the policy interpretation information, so that determining logic of the service policy can be presented intuitively, and credibility of the service policy can be improved well. In addition, because the policy interpretation information is determined based on the deep factor semantic representation feature, an interpretation level of the policy interpretation information is also relatively high, thereby further improving the credibility of the service policy.

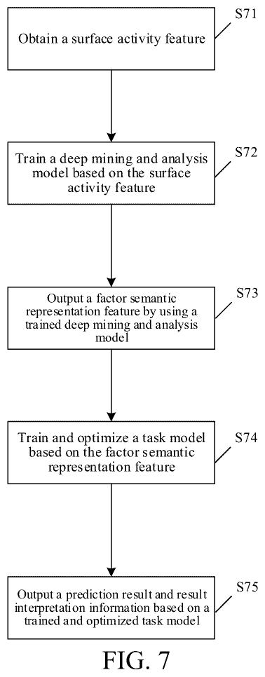

For ease of understanding, FIG. 7 is a schematic diagram of a system process according to an embodiment of the present disclosure. As shown in FIG. 7, the process may include at least the following operation S71 to operation S75.

Operation S71: Obtain a surface activity feature.

Operation S72: Train a deep mining and analysis model based on the surface activity feature.

Operation S73: Output a factor semantic representation feature by using a trained deep mining and analysis model.

Operation S74: Train and optimize a task model based on the factor semantic representation feature.

Specifically, the task model herein may be a decision-making model (for example, the foregoing media data recommendation model) in a service. The task model may be a white-box model, or may be a black-box model.

Operation S75: Output a prediction result and result interpretation information based on a trained and optimized task model.

Specifically, the prediction result herein may be a result (for example, a service policy) outputted by using the task model. The result interpretation information may be information (for example, policy interpretation information for the service policy) configured for interpreting the prediction result. When the task model is the white-box model, the white-box model has interpretability, and may automatically output the result interpretation information. However, when the task model is the black-box model, the black-box model has no interpretability, and the prediction result of the task model may be interpreted by using an interpretable model (for example, a SHAP model).

Specifically, for a specific implementation of operation S71 to operation S75, refer to the descriptions in the foregoing embodiments corresponding to FIG. 2 to FIG. 6. Details are not described herein again. Beneficial effects achieved by the specific implementation are not described herein again.

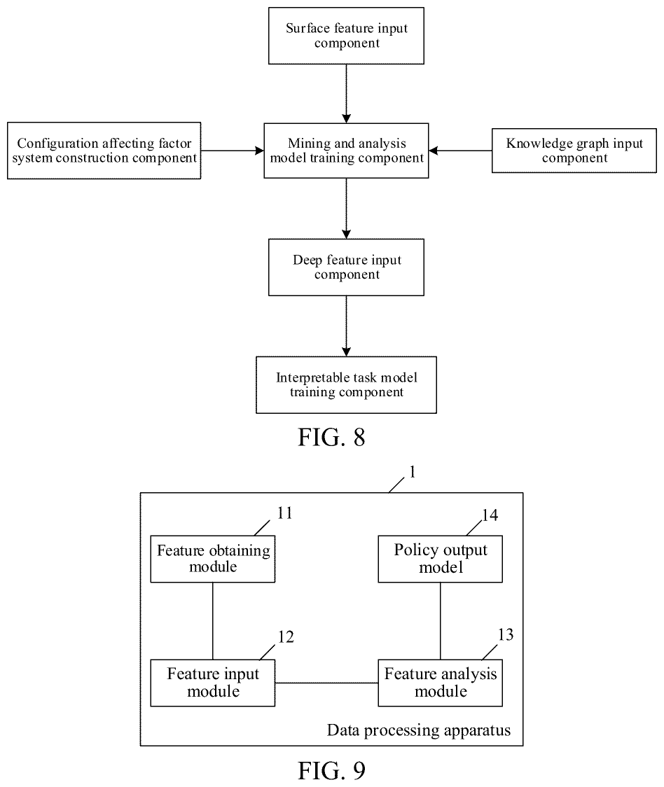

Further, for ease of understanding, FIG. 8 is a diagram of a system architecture of constructing an interpretable task model according to an embodiment of the present disclosure. As shown in FIG. 8, the system architecture may include a configuration affecting factor system construction component, a surface feature input component, a knowledge graph input component, a mining and analysis model training component, a deep feature input component, and an interpretable task model training component. The following describes the components.

The configuration affecting factor system construction component: It can be learned based on the foregoing embodiments that to improve performance of an interpretable task model to analyze the essence of a service by using a surface phenomenon, in the present disclosure, a systematic configuration affecting factor system may be constructed in a manual or semi-automatic manner, and the configuration affecting factor system construction component may be configured to construct the configuration affecting factor system.

The surface feature input component: The surface feature input component may obtain a surface activity feature (which may be a discrete value feature, a continuous value feature, a sequence feature, a graph structure feature, or the like, and a specific form of the surface activity feature is not limited herein) of an object in a service, and input the surface activity feature to the mining and analysis model training component, to train a deep mining and analysis model based on the surface activity feature in the mining and analysis model training component.

The knowledge graph input component: The knowledge graph input component is configured to obtain a knowledge graph of the service, and input the knowledge graph to the mining and analysis model training component, to improve a training effect. Specifically, the knowledge graph may include an association relationship between data in the service. Effectiveness of an outputted factor semantic representation feature can be enhanced by using the knowledge graph. An example in which the service is a shopping service is used. In commodities included in the shopping service, a commodity brand (for example, a cosmetic brand A) may include different products, and all these products are associated with the cosmetic brand A, so that there is an association relationship between these products. In other words, an association relationship between different data in the service may be intuitively learned by using the knowledge graph. The knowledge graph is an option, and the knowledge graph may not be used when the deep mining and analysis model is trained.

The mining and analysis model training component: The mining and analysis model training component may train the deep mining and analysis model based on content inputted by the configuration affecting factor system construction component, content inputted by the surface feature input component, and content inputted by the knowledge graph input component, to improve performance of the deep mining and analysis model to deeply mine one or more factor semantic representation features for the surface activity feature based on the configuration affecting factor system of the service.

The deep feature input component: The deep feature input component may receive content (a factor semantic representation feature of the surface activity feature) inputted by the mining and analysis model training component, and input the content to the interpretable task model training component.

The interpretable task model training component: The interpretable task model training component may train an interpretable task model (a white-box model or a black-box model including an interpretable model) based on the content (the factor semantic representation feature of the surface activity feature) inputted by the deep feature input component, and may output a prediction result (a service policy) and result interpretation information (policy interpretation information) based on a trained interpretable task model.

In one embodiment of in the present disclosure, a feature of the service may be classified into a surface feature (for example, a surface activity feature) and a deep feature (for example, a factor semantic representation feature), so that the configuration affecting factor system may be constructed, and the surface feature may be converted into the deep feature by using the configuration affecting factor system. Therefore, a subsequent task model of a specific task may have a capability of understanding deep knowledge in a task field. For an important decision of the specific task, the task model may provide a more profound and essential prediction result (an outputted service policy is more profound), or may provide deep result interpretation, to better improve credibility of an output result of the task model, so as to improve decision-making efficiency of a decision object (for example, a user) and reduce a probability of a decision failure of the decision object.

Further, FIG. 9 is a schematic structural diagram of a data processing apparatus according to an embodiment of the present disclosure. The data processing apparatus may be a computer program (including program code) running on a computer device. For example, the data processing apparatus is application software. The data processing apparatus may be configured to perform the method shown in FIG. 2. As shown in FIG. 9, the data processing apparatus 1 may include: a feature obtaining module 11, a feature input module 12, a feature analysis module 13, and a policy output module 14.

The feature obtaining module 11 is configured to obtain a service surface activity feature of an object in a service, the service surface activity feature being a behavior activity feature of the object directly corrected in the service.

The feature input module 12 is configured to input the service surface activity feature to a deep mining and analysis model, the deep mining and analysis model being configured to deeply mine one or more factor semantic representation features for a surface activity feature based on a configuration affecting factor system of the service, the configuration affecting factor system including one or more configuration affecting factors that affect the surface activity feature.

The feature analysis module 13 is configured to perform deep mining and analysis processing on the service surface activity feature in the deep mining and analysis model based on the configuration affecting factor system, to obtain a factor semantic representation feature of the service surface activity feature for each configuration affecting factor, a factor semantic representation feature for one configuration affecting factor representing a deep feature of semantics of the configuration affecting factor.

The policy output module 14 is configured to output a service policy of the object for the service and policy interpretation information for the service policy based on the factor semantic representation feature of the service surface activity feature for each configuration affecting factor, wherein the policy interpretation information interprets a calculation logic of the service policy.

For specific implementations of the feature obtaining module 11, the feature input module 12, the feature analysis module 13, and the policy output module 14, refer to the descriptions of operation S101 to operation S103 in the foregoing embodiment corresponding to FIG. 2. Details are not described herein again.

In an embodiment, the service is an item recommendation service; and the configuration affecting factor includes a virtual resource status factor.

The feature analysis module 13 is further specifically configured to obtain, in the service surface activity feature, a virtual resource activity feature of the object associated with the virtual resource status factor, the virtual resource activity feature including regional information of the object and an exchange frequency of the object for a target type item, and the target type item being an item having an attribute value greater than a threshold.

The feature analysis module 13 is further specifically configured to determine a virtual resource status of the object as a sufficient state when a region type to which the regional information belongs is a high-quality region type and the exchange frequency is greater than a frequency threshold, generate a first factor semantic representation feature configured for reflecting the sufficient state, and determine the first factor semantic representation feature as a factor semantic representation feature of the service surface activity feature for the virtual resource status factor.

The feature analysis module 13 is further specifically configured to determine a virtual resource status of the object as a deficient state when a region type to which the regional information belongs is a common region type or the exchange frequency is less than a frequency threshold, generate a second factor semantic representation feature configured for reflecting the deficient state, and determine the second factor semantic representation feature as a factor semantic representation feature of the service surface activity feature for the virtual resource status factor.

In an embodiment, the configuration affecting factor system includes a configuration affecting factor Sᵢ, and i is a positive integer.

The feature analysis module 13 is further specifically configured to perform deep mining and analysis processing on the service surface activity feature in the deep mining and analysis model based on the configuration affecting factor system, to output an initial factor semantic representation feature of the service surface activity feature for each configuration affecting factor.

The feature analysis module 13 is further specifically configured to determine configuration affecting factors other than the configuration affecting factor Sᵢ in the configuration affecting factor system as remaining configuration affecting factors.

The feature analysis module 13 is further specifically configured to perform semantic constraint processing on an initial factor semantic representation feature of the service surface activity feature for the configuration affecting factor Sᵢ according to initial factor semantic representation features of the service surface activity feature for the remaining configuration affecting factors, to obtain a factor semantic representation feature of the service surface activity feature for the configuration affecting factor Si.

In an embodiment, there are at least two remaining configuration affecting factors.

The feature analysis module 13 is further specifically configured to determine the initial factor semantic representation feature of the service surface activity feature for the configuration affecting factor Si as a target initial representation feature, and determine an initial factor semantic representation feature of the service surface activity feature for each of the remaining configuration affecting factors as a to-be-fused representation feature corresponding to the target initial representation feature.

The feature analysis module 13 is further specifically configured to determine any one of at least two to-be-fused representation features as a target to-be-fused representation feature, and perform fusion processing on the target initial representation feature and the target to-be-fused representation feature, to obtain a fused representation feature corresponding to the target to-be-fused representation feature.

The feature analysis module 13 is further specifically configured to perform semantic constraint processing on the target initial representation feature based on fused representation features respectively corresponding to the at least two to-be-fused representation features, to obtain the factor semantic representation feature of the service surface activity feature for the configuration affecting factor Si.

In an embodiment, the feature analysis module 13 is further specifically configured to obtain a to-be-clustered object set, the to-be-clustered object set including at least two to-be-clustered objects.

The feature analysis module 13 is further specifically configured to perform clustering processing on the at least two to-be-clustered objects based on the target initial representation feature, to obtain a first class cluster distribution result, the first class cluster distribution result including a first class cluster and a second class cluster; a class cluster category to which the first class cluster belongs being a first factor category derived based on the configuration affecting factor Sᵢ, a class cluster category to which the second class cluster belongs being a second factor category derived based on the configuration affecting factor Sᵢ, and the first factor category being different from the second factor category.

The feature analysis module 13 is further specifically configured to determine any one of at least two fused representation features as a target fused representation feature, and perform clustering processing on the at least two to-be-clustered objects based on the target fused representation feature, to obtain a second class cluster distribution result, the second class cluster distribution result including a third class cluster and a fourth class cluster, a class cluster category to which the third class cluster belongs being the first factor category, and a class cluster category to which the fourth class cluster belongs being the second factor category.

The feature analysis module 13 is further specifically configured to determine a feature distinguishing attribute of the target initial representation feature for the target fused representation feature according to the first class cluster, the second class cluster, the third class cluster, and the fourth class cluster.

The feature analysis module 13 is further specifically configured to determine the factor semantic representation feature of the service surface activity feature for the configuration affecting factor Sᵢ based on a feature distinguishing attribute of the target initial representation feature for each fused representation feature.

In an embodiment, the feature analysis module 13 is further specifically configured to obtain a real factor category label corresponding to each of the at least two to-be-clustered objects.

The feature analysis module 13 is further specifically configured to combine to-be-clustered objects whose real factor category labels are the first factor category, to obtain a first real label class cluster, and combine to-be-clustered objects whose real factor category labels are the second factor category, to obtain a second real label class cluster.

The feature analysis module 13 is further specifically configured to determine a first clustering error corresponding to the target initial representation feature based on the first class cluster, the second class cluster, the first real label class cluster, and the second real label class cluster.

The feature analysis module 13 is further specifically configured to determine a second clustering error corresponding to the target fused representation feature based on the third class cluster, the fourth class cluster, the first real label class cluster, and the second real label class cluster.

The feature analysis module 13 is further specifically configured to determine the feature distinguishing attribute of the target initial representation feature for the target fused representation feature as a feature abnormality distinguishing attribute when the first clustering error is greater than the second clustering error and an absolute value of an error difference between the first clustering error and the second clustering error is greater than a difference threshold.

The feature analysis module 13 is further specifically configured to determine the feature distinguishing attribute of the target initial representation feature for the target fused representation feature as a feature normality distinguishing attribute when the first clustering error is less than the second clustering error or an absolute value of an error difference between the first clustering error and the second clustering error is less than a difference threshold.

In an embodiment, the feature analysis module 13 is further specifically configured to determine a set formed by the feature distinguishing attribute of the target initial representation feature for each fused representation feature as an attribute set.

The feature analysis module 13 is further specifically configured to traverse the attribute set.

The feature analysis module 13 is further specifically configured to: if a feature abnormality distinguishing attribute exists in the attribute set, determine a feature constraint attribute of the target initial representation feature as a constraint-deficient attribute, optimize the deep mining and analysis model based on an absolute value of an error difference, and perform deep mining and analysis processing on the service surface activity feature in an optimized deep mining and analysis model based on the configuration affecting factor system, to obtain the factor semantic representation feature of the service surface activity feature for the configuration affecting factor Sᵢ.

The feature analysis module 13 is further specifically configured to if a feature abnormality distinguishing attribute does not exist in the attribute set, determine a feature constraint attribute of the target initial representation feature as a constraint-sufficient attribute, and determine the target initial representation feature as the factor semantic representation feature of the service surface activity feature for the configuration affecting factor Sᵢ.

In an embodiment, the service is a media data recommendation service; the service policy refers to recommended media data for the object; and the policy interpretation information is recommendation interpretation information for the recommended media data.

The policy output module 14 is further specifically configured to determine a set formed by the factor semantic representation feature of the service surface activity feature for each configuration affecting factor as a factor semantic representation feature set.

The policy output module 14 is further specifically configured to input the factor semantic representation feature set to a media data recommendation model, the media data recommendation model being obtained by training and optimizing a sample media data recommendation model based on a sample factor semantic representation feature set of a sample object in the media data recommendation service, the sample factor semantic representation feature set including a sample factor semantic representation feature of a sample service surface activity feature for each configuration affecting factor, and the sample service surface activity feature being a surface activity feature of the sample object in the media data recommendation model.

The policy output module 14 is further specifically configured to output, by using the media data recommendation model, recommended media data corresponding to the factor semantic representation feature set.

The policy output module 14 is further specifically configured to determine recommendation interpretation information for the recommended media data based on a model attribute of the media data recommendation model, the model attribute including a black-box attribute and a white-box attribute.

In an embodiment, the model attribute of the media data recommendation model is the black-box attribute.

The policy output module 14 is further specifically configured to obtain an interpretable model configured to perform result interpretation on a model result outputted by the media data recommendation model.

The policy output module 14 is further specifically configured to input the factor semantic representation feature set and the recommended media data to the interpretable model, and output, by using the interpretable model, a feature impact value corresponding to each factor semantic representation feature in the factor semantic representation feature set, to obtain a feature impact value set, one feature impact value in the feature impact value set representing an impact degree of a corresponding factor semantic representation feature on the recommended media data.

The policy output module 14 is further specifically configured to generate the recommendation interpretation information for the recommended media data based on the feature impact value set.

In an embodiment, the policy output module 14 is further specifically configured to sort each feature impact value according to a magnitude of each feature impact value in the feature impact value set, to obtain an impact value sequence.

The policy output module 14 is further specifically configured to determine factor semantic representation features respectively corresponding to the first K feature impact values in the impact value sequence as high-impact representation features.

The policy output module 14 is further specifically configured to generate the recommendation interpretation information for the recommended media data based on factor semantics reflected by the high-impact representation features.

According to an embodiment of the present disclosure, the operations in the data processing method shown in FIG. 2 may be performed by the modules of the data processing apparatus 1 shown in FIG. 9. For example, operation S101 shown in FIG. 2 may be performed by the feature obtaining module 11 and the feature input module 12 in FIG. 9, and operation S102 shown in FIG. 2 may be performed by the feature analysis module 13 in FIG. 9. Operation S103 shown in FIG. 2 may be performed by the policy output module 14 in FIG. 9.

In one embodiment of the present disclosure, when a service policy for a service is formulated for an object, a service surface activity feature of the object in the service may be first obtained, and deep mining and analysis processing may be performed on the service surface activity feature by using a deep mining and analysis model, so that the service surface activity feature may be converted into one or more deep factor semantic representation features. Subsequently, the service policy of the object in the service may be determined based on the factor semantic representation features. Moreover, policy interpretation information (information configured for interpreting the service policy) for the service policy may be outputted based on the factor semantic representation features. In the present disclosure, a configuration affecting factor system of a service may be constructed, and then a service surface activity feature of an object in the service may be converted into a deep factor semantic representation feature by using a deep mining and analysis model. A service policy of the object for the service is determined and outputted based on the deep factor semantic representation feature instead of being determined based on a surface activity feature, thereby better improving accuracy of the service policy. In addition, in the present disclosure, when the service policy is determined and outputted, policy interpretation information for the service policy may be further outputted. A reason for determining the service policy may be well explained by using the policy interpretation information, so that determining logic of the service policy can be presented intuitively, and credibility of the service policy can be improved well. In addition, because the policy interpretation information is determined based on the deep factor semantic representation feature, an interpretation level of the policy interpretation information is also relatively high, thereby further improving the credibility of the service policy. Based on the foregoing, through the apparatus provided in the present disclosure, in a task of determining a service policy, credibility of the determined service policy can be improved.

According to an embodiment of the present disclosure, modules in the data processing apparatus 1 shown in FIG. 9 may be separately or wholly combined into one or several units, or one (or more) of the units herein may further be divided into a plurality of subunits of smaller functions. In this way, same operations can be implemented, and implementation of the technical effects of the embodiments of the present disclosure is not affected. The foregoing modules are divided based on logical functions. In an actual application, a function of one module may also be implemented by a plurality of units, or functions of a plurality of modules are implemented by one unit. In other embodiments of the present disclosure, the data processing apparatus 1 may also include other units. During actual application, the functions may also be cooperatively implemented by other units and may be cooperatively implemented by a plurality of units.

According to an embodiment of the present disclosure, a computer program (including program code) that can perform the operations in the corresponding method shown in FIG. 2 may be run on a general computer device, such as a computer, which includes processing elements and storage elements such as a central processing unit (CPU), a random access memory (RAM), and a read-only memory (ROM), to construct the data processing apparatus 1 shown in FIG. 9 and implement the data processing method in the embodiments of the present disclosure. The computer program may be recorded in, for example, a computer-readable recording medium, and may be loaded into the foregoing computer device by using the computer-readable recording medium, and run in the computer device.

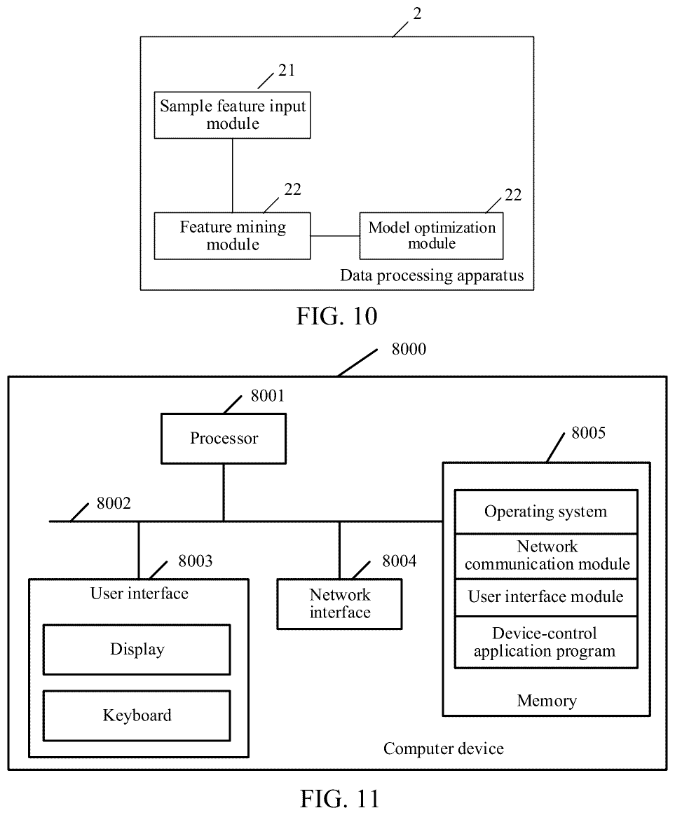

Further, FIG. 10 is a schematic structural diagram of another data processing apparatus according to an embodiment of the present disclosure. The data processing apparatus may be a computer program (including program code) running on a computer device. For example, the data processing apparatus is application software. The data processing apparatus may be configured to perform the method shown in FIG. 6. As shown in FIG. 10, the data processing apparatus 2 may include: a sample feature input module 21, a feature mining module 22, and a model optimization module 23.

The sample feature input module 21 is configured to obtain a sample service surface activity feature of a sample object in a service, and input the sample service surface activity feature to a sample deep mining and analysis model, the sample service surface activity feature being a behavior activity feature that is of the sample object in the service and that can be directly collected, the sample deep mining and analysis model being configured to deeply mine one or more factor semantic representation features for a surface activity feature based on a configuration affecting factor system of the service, the configuration affecting factor system including one or more configuration affecting factors that affect the surface activity feature.

The feature mining module 22 is configured to perform deep mining and analysis processing on the sample service surface activity feature in the sample deep mining and analysis model based on the configuration affecting factor system, to obtain an initial sample factor semantic representation feature of the sample service surface activity feature for each configuration affecting factor, an initial sample factor semantic representation feature for one configuration affecting factor representing a deep feature of semantics of the configuration affecting factor.

The model optimization module 23 is configured to train and optimize the sample deep mining and analysis model based on the initial sample factor semantic representation feature of the sample service surface activity feature for each configuration affecting factor, to obtain a deep mining and analysis model, the deep mining and analysis model being configured to perform deep mining and analysis processing on a service surface activity feature of an object in the service based on the configuration affecting factor system, to obtain a factor semantic representation feature of the service surface activity feature for each configuration affecting factor.

For specific implementations of the sample feature input module 21, the feature mining module 22, and the model optimization module 23, refer to the descriptions of operation S601 to operation S603 in the foregoing embodiment corresponding to FIG. 6. Details are not described herein again.

In an embodiment, the configuration affecting factor system includes a configuration affecting factor Sᵢ, and i is a positive integer.

The model optimization module 23 is further specifically configured to determine an initial sample factor semantic representation feature of the sample service surface activity feature for the configuration affecting factor Si as a target initial sample representation feature.

The model optimization module 23 is further specifically configured to perform semantic constraint processing on the target initial sample representation feature, to obtain a sample feature constraint attribute corresponding to the target initial sample representation feature.

The model optimization module 23 is further specifically configured to: when determining a sample feature constraint attribute corresponding to each initial sample factor semantic representation feature, determine a set formed by the sample feature constraint attribute corresponding to each initial sample factor semantic representation feature as a sample constraint attribute set.

The model optimization module 23 is further specifically configured to: if a constraint-deficient attribute exists in the sample constraint attribute set, adjust a model parameter of the sample deep mining and analysis model based on an initial sample factor semantic representation feature corresponding to the constraint-deficient attribute, to obtain an adjusted model parameter, and determine a sample deep mining and analysis model including the adjusted model parameter as the deep mining and analysis model.

The model optimization module 23 is further specifically configured to: if no constraint-deficient attribute exists in the sample constraint attribute set, determine the sample deep mining and analysis model as the deep mining and analysis model.

In one embodiment, a configuration affecting factor system of a service may be constructed, and then a service surface activity feature of an object in the service may be converted into a deep factor semantic representation feature by using a deep mining and analysis model. A service policy of the object for the service is determined and outputted based on the deep factor semantic representation feature instead of being determined based on a surface activity feature, thereby better improving accuracy of the service policy. In addition, in the present disclosure, when the service policy is determined and outputted, policy interpretation information for the service policy may be further outputted. A reason for determining the service policy may be well explained by using the policy interpretation information, so that determining logic of the service policy can be presented intuitively, and credibility of the service policy can be improved well. In addition, because the policy interpretation information is determined based on the deep factor semantic representation feature, an interpretation level of the policy interpretation information is also relatively high, thereby further improving the credibility of the service policy.

According to an embodiment of the present disclosure, modules in the data processing apparatus 2 shown in FIG. 10 may be separately or wholly combined into one or several units, or one (or more) of the units herein may further be divided into a plurality of subunits of smaller functions. In this way, same operations can be implemented, and implementation of the technical effects of the embodiments of the present disclosure is not affected. The foregoing modules are divided based on logical functions. In an actual application, a function of one module may also be implemented by a plurality of units, or functions of a plurality of modules are implemented by one unit. In other embodiments of the present disclosure, the data processing apparatus 2 may also include other units. During actual application, the functions may also be cooperatively implemented by other units and may be cooperatively implemented by a plurality of units.

According to an embodiment of the present disclosure, a computer program (including program code) that can perform the operations in the corresponding method shown in FIG. 6 may be run on a general computer device, such as a computer, which includes processing elements and storage elements such as a central processing unit (CPU), a random access memory (RAM), and a read-only memory (ROM), to construct the data processing apparatus 2 shown in FIG. 10 and implement the data processing method in the embodiments of the present disclosure. The computer program may be recorded in, for example, a computer-readable recording medium, and may be loaded into the foregoing computer device by using the computer-readable recording medium, and run in the computer device.

Further, FIG. 11 is a schematic structural diagram of a computer device according to an embodiment of the present disclosure. As shown in FIG. 11, the data processing apparatus 1 in the embodiment corresponding to FIG. 9, or the data processing apparatus 2 in the embodiment corresponding to FIG. 10 may be used in the computer device 8000. The computer device 8000 may include: a processor 8001, a network interface 8004, and a memory 8005. In addition, the computer device 8000 further includes: a user interface 8003 and at least one communication bus 8002. The communication bus 8002 is configured to implement connection and communication between the components. The user interface 8003 may include a display, a keyboard, and in some embodiments, the user interface 8003 may further include a standard wired interface and a standard wireless interface. In some embodiments, the network interface 8004 may include a standard wired interface and a standard wireless interface (for example, a Wi-Fi interface). The memory 8005 may be a high-speed random access memory (RAM), or may be a non-volatile memory, for example, at least one magnetic disk memory. In some embodiments, the memory 8005 may be at least one storage apparatus that is located far away from the foregoing processor 8001. As shown in FIG. 11, the memory 8005 used as a computer-readable storage medium may include an operating system, a network communication module, a user interface module, and a device-control application program.

In the computer device 8000 shown in FIG. 11, the network interface 8004 may provide a network communication function. The user interface 8003 is mainly configured to provide an input interface for a user. The processor 8001 may be configured to invoke the device-control application program stored in the memory 8005, to implement:
obtaining a service surface activity feature of an object in a service, and inputting the service surface activity feature to a deep mining and analysis model, the service surface activity feature being a behavior activity feature of the object directly corrected in the service, the deep mining and analysis model being configured to deeply mine one or more factor semantic representation features for a surface activity feature based on a configuration affecting factor system of the service, the configuration affecting factor system including one or more configuration affecting factors that affect the surface activity feature;
performing deep mining and analysis processing on the service surface activity feature in the deep mining and analysis model based on the configuration affecting factor system, to obtain a factor semantic representation feature of the service surface activity feature for each configuration affecting factor, a factor semantic representation feature for one configuration affecting factor representing a deep feature of semantics of the configuration affecting factor, and
outputting a service policy of the object for the service and policy interpretation information for the service policy based on the factor semantic representation feature of the service surface activity feature for each configuration affecting factor, wherein the policy interpretation information interprets a calculation logic of the service policy.

Alternatively, the processor 8001 may be configured to invoke a device-controlled application program stored in the memory 8005, to implement:
obtaining a sample service surface activity feature of a sample object in a service, and inputting the sample service surface activity feature to a sample deep mining and analysis model, the sample service surface activity feature being a behavior activity feature that is of the sample object in the service and that can be directly collected, the sample deep mining and analysis model being configured to deeply mine one or more factor semantic representation features for a surface activity feature based on a configuration affecting factor system of the service, the configuration affecting factor system including one or more configuration affecting factors that affect the surface activity feature;
performing deep mining and analysis processing on the sample service surface activity feature in the sample deep mining and analysis model based on the configuration affecting factor system, to obtain an initial sample factor semantic representation feature of the sample service surface activity feature for each configuration affecting factor, an initial sample factor semantic representation feature for one configuration affecting factor representing a deep feature of semantics of the configuration affecting factor; and
training and optimizing the sample deep mining and analysis model based on the initial sample factor semantic representation feature of the sample service surface activity feature for each configuration affecting factor, to obtain a deep mining and analysis model, the deep mining and analysis model being configured to perform deep mining and analysis processing on a service surface activity feature of an object in the service based on the configuration affecting factor system, to obtain a factor semantic representation feature of the service surface activity feature for each configuration affecting factor.

The computer device 8000 described in one embodiment of the present disclosure can implement the descriptions of the data processing method in the foregoing embodiments corresponding to FIG. 2 to FIG. 6, and can also implement the descriptions of the data processing apparatus 1 in the foregoing embodiment corresponding to FIG. 9 or the descriptions of the data processing apparatus 2 in the foregoing embodiment corresponding to FIG. 10. Details are not described herein again. In addition, beneficial effects achieved by using the same method are not described herein again.

In addition, an embodiment of the present disclosure further provides a computer-readable storage medium. The computer-readable storage medium stores a computer program executed by the computer device 8000 for data processing mentioned above, and the computer program includes program instructions. When executing the program instructions, the processor can perform the descriptions of the data processing method in the foregoing embodiments corresponding to FIG. 2 to FIG. 6. Therefore, details are not described herein again. In addition, beneficial effects achieved by using the same method are not described herein again. For technical details that are not disclosed in the embodiments of the computer-readable storage medium of the present disclosure, refer to the method embodiments of the present disclosure.

The computer-readable storage medium may be the data processing apparatus provided in any of the foregoing embodiments or an internal storage unit of the computer device, for example, a hard disk or an internal memory of the computer device. The computer-readable storage medium may also be an external storage device of the computer device, such as a plug-in hard disk, a smart media card (SMC), a secure digital (SD) card, or a flash card that is equipped on the computer device. Further, the computer-readable storage medium may also include an internal storage unit of the computer device and an external storage device. The computer-readable storage medium is configured for storing the computer program and another program and data required by the computer device. The computer-readable storage medium may be further used for temporarily storing data that has been outputted or will be outputted.

An aspect of the present disclosure provides a computer program product or a computer program, including computer instructions, the computer instructions being stored in a computer-readable storage medium. A processor of a computer device reads the computer instructions from the computer-readable storage medium, and the processor executes the computer instructions, to enable the computer device to perform the method provided in the aspect of the embodiments of the present disclosure.

In the specification, claims, and accompanying drawings of the embodiment of the present disclosure, the terms “first”, “second”, and the like are intended to distinguish between different objects but do not indicate a particular order. In addition, the terms “include” and any variant thereof are intended to cover a non-exclusive inclusion. For example, a process, method, apparatus, product, or device that includes a series of steps or units is not limited to the listed steps or modules, but further includes a step or a module that is not listed, or in some embodiments, includes another step unit that is intrinsic to the process, method, apparatus, product, or device.

A person of ordinary skill in the art may be aware that, the units and steps in the examples described with reference to the embodiments disclosed herein can be implemented by electronic hardware, computer software, or a combination thereof. To clearly describe the interchangeability between the hardware and the software, the foregoing has usually described compositions and steps of each example according to functions. Whether the functions are performed by hardware or software depends on particular applications and design constraint conditions of the technical solutions. A person skilled in the art may use different methods to implement the described functions for each particular application, but it is not to be considered that the implementation goes beyond the scope of the present disclosure.

The method and related apparatus provided in the embodiments of the present disclosure are described with reference to the method flowchart and/or the schematic structural diagram provided in the embodiments of the present disclosure. Specifically, the computer program instructions implement each process and/or each block in the method flowchart and/or the schematic structural diagram and a combination of a process and/or a block in the flowchart and the block diagram. These computer program instructions may be provided to a general-purpose computer, a dedicated computer, an embedded processor, or a processor of another programmable data processing device to generate a machine, so that the instructions executed by the computer or the processor of the another programmable data processing device generate an apparatus for implementing a specific function in one or more processes in the flowcharts and/or in one or more blocks in the schematic structural diagrams. These computer program instructions may alternatively be stored in a computer-readable memory that can instruct a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams. These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the schematic structural diagrams.

What is disclosed above is merely exemplary embodiments of the present disclosure, and certainly is not intended to limit the scope of the claims of the present disclosure. Therefore, equivalent variations made in accordance with the claims of the present disclosure shall fall within the scope of the present disclosure.

What is claimed is:

1. A data processing method, performed by a computer device, the method comprising:
obtaining a service surface activity feature of an object in a service, and inputting the service surface activity feature to a deep mining and analysis model, the service surface activity feature being a behavior activity feature of the object directly corrected in the service, the deep mining and analysis model being configured to deeply mine one or more factor semantic representation features for a surface activity feature based on a configuration affecting factor system of the service, the configuration affecting factor system comprising one or more configuration affecting factors that affect the surface activity feature;
performing deep mining and analysis processing on the service surface activity feature in the deep mining and analysis model based on the configuration affecting factor system, to obtain a factor semantic representation feature of the service surface activity feature for each configuration affecting factor, a factor semantic representation feature for one configuration affecting factor representing a deep feature of semantics of the configuration affecting factor; and
outputting a service policy of the object for the service and policy interpretation information for the service policy based on the factor semantic representation feature of the service surface activity feature for each configuration affecting factor, wherein the policy interpretation information interprets a calculation logic of the service policy.

2. The method according to claim 1, wherein the service is an item recommendation service; the configuration affecting factor comprises a virtual resource status factor; and
the performing deep mining and analysis processing on the service surface activity feature in the deep mining and analysis model based on the configuration affecting factor system, to obtain a factor semantic representation feature of the service surface activity feature for each configuration affecting factor comprises:
obtaining, in the service surface activity feature, a virtual resource activity feature of the object associated with the virtual resource status factor, the virtual resource activity feature comprising regional information of the object and an exchange frequency of the object for a target type item, and the target type item being an item having an attribute value greater than a threshold; and
determining a virtual resource status of the object as a sufficient state when a region type to which the regional information belongs is a first region type and the exchange frequency is greater than a frequency threshold, generating a first factor semantic representation feature that reflects the sufficient state, and determining the first factor semantic representation feature as a factor semantic representation feature of the service surface activity feature for the virtual resource status factor; or
determining a virtual resource status of the object as a deficient state when a region type to which the regional information belongs is a second region type or the exchange frequency is less than a frequency threshold, generating a second factor semantic representation feature that reflects the deficient state, and determining the second factor semantic representation feature as a factor semantic representation feature of the service surface activity feature for the virtual resource status factor.

3. The method according to claim 1, wherein the configuration affecting factor system comprises a configuration affecting factor Sᵢ, and i is a positive integer; and
the performing deep mining and analysis processing on the service surface activity feature in the deep mining and analysis model based on the configuration affecting factor system, to obtain a factor semantic representation feature of the service surface activity feature for each configuration affecting factor comprises:
performing deep mining and analysis processing on the service surface activity feature in the deep mining and analysis model based on the configuration affecting factor system, to output an initial factor semantic representation feature of the service surface activity feature for each configuration affecting factor;
determining configuration affecting factors other than the configuration affecting factor Sᵢ in the configuration affecting factor system as remaining configuration affecting factors; and
performing semantic constraint processing on an initial factor semantic representation feature of the service surface activity feature for the configuration affecting factor Sᵢ according to initial factor semantic representation features of the service surface activity feature for the remaining configuration affecting factors, to obtain a factor semantic representation feature of the service surface activity feature for the configuration affecting factor Si.

4. The method according to claim 3, wherein there are at least two remaining configuration affecting factors; and
the performing semantic constraint processing on an initial factor semantic representation feature of the service surface activity feature for the configuration affecting factor Sᵢ according to initial factor semantic representation features of the service surface activity feature for the remaining configuration affecting factors, to obtain a factor semantic representation feature of the service surface activity feature for the configuration affecting factor Sᵢ comprises:
determining the initial factor semantic representation feature of the service surface activity feature for the configuration affecting factor Si as a target initial representation feature, and determining an initial factor semantic representation feature of the service surface activity feature for each of the remaining configuration affecting factors as a to-be-fused representation feature corresponding to the target initial representation feature;
determining one of at least two to-be-fused representation features as a target to-be-fused representation feature, and performing fusion processing on the target initial representation feature and the target to-be-fused representation feature, to obtain a fused representation feature corresponding to the target to-be-fused representation feature; and
performing semantic constraint processing on the target initial representation feature based on fused representation features respectively corresponding to the at least two to-be-fused representation features, to obtain the factor semantic representation feature of the service surface activity feature for the configuration affecting factor Si.

5. The method according to claim 4, wherein the performing semantic constraint processing on the target initial representation feature based on fused representation features respectively corresponding to the at least two to-be-fused representation features, to obtain the factor semantic representation feature of the service surface activity feature for the configuration affecting factor Sᵢ comprises:
obtaining an object set, the object set comprising at least two objects to be clustered;
performing clustering processing on the at least two objects based on the target initial representation feature, to obtain a first class cluster distribution result, the first class cluster distribution result comprising a first class cluster and a second class cluster, a class cluster category to which the first class cluster belongs being a first factor category derived based on the configuration affecting factor Sᵢ, a class cluster category to which the second class cluster belongs being a second factor category derived based on the configuration affecting factor Sᵢ, and the first factor category being different from the second factor category;
determining one of at least two fused representation features as a target fused representation feature, and performing clustering processing on the at least two objects based on the target fused representation feature, to obtain a second class cluster distribution result, the second class cluster distribution result comprising a third class cluster and a fourth class cluster, a class cluster category to which the third class cluster belongs being the first factor category, and a class cluster category to which the fourth class cluster belongs being the second factor category;
determining a feature distinguishing attribute of the target initial representation feature for the target fused representation feature according to the first class cluster, the second class cluster, the third class cluster, and the fourth class cluster; and
determining the factor semantic representation feature of the service surface activity feature for the configuration affecting factor Si based on a feature distinguishing attribute of the target initial representation feature for each fused representation feature.

6. The method according to claim 5, wherein the determining a feature distinguishing attribute of the target initial representation feature for the target fused representation feature according to the first class cluster, the second class cluster, the third class cluster, and the fourth class cluster comprises:
obtaining a real factor category label corresponding to each of the at least two objects;
combining objects whose real factor category labels are the first factor category, to obtain a first real label class cluster, and combining objects whose real factor category labels are the second factor category, to obtain a second real label class cluster;
determining a first clustering error corresponding to the target initial representation feature based on the first class cluster, the second class cluster, the first real label class cluster, and the second real label class cluster;
determining a second clustering error corresponding to the target fused representation feature based on the third class cluster, the fourth class cluster, the first real label class cluster, and the second real label class cluster; and
determining the feature distinguishing attribute of the target initial representation feature for the target fused representation feature as a feature abnormality distinguishing attribute when the first clustering error is greater than the second clustering error and an absolute value of an error difference between the first clustering error and the second clustering error is greater than a difference threshold; or
determining the feature distinguishing attribute of the target initial representation feature for the target fused representation feature as a feature normality distinguishing attribute when the first clustering error is less than the second clustering error or an absolute value of an error difference between the first clustering error and the second clustering error is less than a difference threshold.

7. The method according to claim 5, wherein the determining the factor semantic representation feature of the service surface activity feature for the configuration affecting factor Sᵢ based on a feature distinguishing attribute of the target initial representation feature for each fused representation feature comprises:
determining a set formed by the feature distinguishing attribute of the target initial representation feature for each fused representation feature as an attribute set;
traversing the attribute set; and
if a feature abnormality distinguishing attribute exists in the attribute set, determining a feature constraint attribute of the target initial representation feature as a constraint-deficient attribute, optimizing the deep mining and analysis model based on an absolute value of an error difference, and performing deep mining and analysis processing on the service surface activity feature in an optimized deep mining and analysis model based on the configuration affecting factor system, to obtain the factor semantic representation feature of the service surface activity feature for the configuration affecting factor Sᵢ; or
if a feature abnormality distinguishing attribute does not exist in the attribute set, determining a feature constraint attribute of the target initial representation feature as a constraint-sufficient attribute, and determining the target initial representation feature as the factor semantic representation feature of the service surface activity feature for the configuration affecting factor Sᵢ.

8. The method according to claim 1, wherein the service is a media data recommendation service; the service policy refers to recommended media data for the object; the policy interpretation information is recommendation interpretation information for the recommended media data; and
the outputting a service policy of the object for the service and policy interpretation information for the service policy based on the factor semantic representation feature of the service surface activity feature for each configuration affecting factor comprises:
determining a set formed by the factor semantic representation feature of the service surface activity feature for each configuration affecting factor as a factor semantic representation feature set;
inputting the factor semantic representation feature set to a media data recommendation model, the media data recommendation model being obtained by training and optimizing a sample media data recommendation model based on a sample factor semantic representation feature set of a sample object in the media data recommendation service, the sample factor semantic representation feature set comprising a sample factor semantic representation feature of a sample service surface activity feature for each configuration affecting factor, and the sample service surface activity feature being a surface activity feature of the sample object in the media data recommendation model;
outputting, by using the media data recommendation model, recommended media data corresponding to the factor semantic representation feature set; and
determining recommendation interpretation information for the recommended media data based on a model attribute of the media data recommendation model, the model attribute comprising a black-box attribute and a white-box attribute.

9. The method according to claim 8, wherein the model attribute of the media data recommendation model is the black-box attribute; and
the determining recommendation interpretation information for the recommended media data based on a model attribute of the media data recommendation model comprises:
obtaining an interpretable model configured to perform result interpretation on a model result outputted by the media data recommendation model;
inputting the factor semantic representation feature set and the recommended media data to the interpretable model, and outputting, by using the interpretable model, a feature impact value corresponding to each factor semantic representation feature in the factor semantic representation feature set, to obtain a feature impact value set, one feature impact value in the feature impact value set representing an impact degree of a corresponding factor semantic representation feature on the recommended media data; and
generating the recommendation interpretation information for the recommended media data based on the feature impact value set.

10. The method according to claim 9, wherein the generating the recommendation interpretation information for the recommended media data based on the feature impact value set comprises:
sorting each feature impact value according to a magnitude of each feature impact value in the feature impact value set, to obtain an impact value sequence;
determining factor semantic representation features respectively corresponding to the first K feature impact values in the impact value sequence as high-impact representation features; and
generating the recommendation interpretation information for the recommended media data based on factor semantics reflected by the high-impact representation features.

11. The method according to claim 1, wherein the deep mining and analysis model is obtained by:
obtaining a sample service surface activity feature of a sample object in a service, and inputting the sample service surface activity feature to a sample deep mining and analysis model, the sample service surface activity feature being a behavior activity feature of the sample object directly corrected in the service, the sample deep mining and analysis model being configured to deeply mine one or more factor semantic representation features for a surface activity feature based on the configuration affecting factor system of the service;
performing deep mining and analysis processing on the sample service surface activity feature in the sample deep mining and analysis model based on the configuration affecting factor system, to obtain an initial sample factor semantic representation feature of the sample service surface activity feature for each configuration affecting factor, an initial sample factor semantic representation feature for one configuration affecting factor representing a deep feature of semantics of the configuration affecting factor; and
training and optimizing the sample deep mining and analysis model based on the initial sample factor semantic representation feature of the sample service surface activity feature for each configuration affecting factor, to obtain the deep mining and analysis model.

12. The method according to claim 11, wherein the configuration affecting factor system comprises a configuration affecting factor Sᵢ, and i is a positive integer; and
the training and optimizing the sample deep mining and analysis model based on the initial sample factor semantic representation feature of the sample service surface activity feature for each configuration affecting factor, to obtain a deep mining and analysis model comprises:
determining an initial sample factor semantic representation feature of the sample service surface activity feature for the configuration affecting factor Sᵢ as a target initial sample representation feature;
performing semantic constraint processing on the target initial sample representation feature, to obtain a sample feature constraint attribute corresponding to the target initial sample representation feature;
when determining a sample feature constraint attribute corresponding to each initial sample factor semantic representation feature, determining a set formed by the sample feature constraint attribute corresponding to each initial sample factor semantic representation feature as a sample constraint attribute set; and
if a constraint-deficient attribute exists in the sample constraint attribute set, adjusting a model parameter of the sample deep mining and analysis model based on an initial sample factor semantic representation feature corresponding to the constraint-deficient attribute, to obtain an adjusted model parameter, and determining a sample deep mining and analysis model comprising the adjusted model parameter as the deep mining and analysis model; or
if no constraint-deficient attribute exists in the sample constraint attribute set, determining the sample deep mining and analysis model as the deep mining and analysis model.

13. A computer device, comprising a processor, and a memory,
the memory being configured to store a computer program, and the processor being configured to invoke the computer program to perform:
obtaining a service surface activity feature of an object in a service, and inputting the service surface activity feature to a deep mining and analysis model, the service surface activity feature being a behavior activity feature of the object directly corrected in the service, the deep mining and analysis model being configured to deeply mine one or more factor semantic representation features for a surface activity feature based on a configuration affecting factor system of the service, the configuration affecting factor system comprising one or more configuration affecting factors that affect the surface activity feature;
performing deep mining and analysis processing on the service surface activity feature in the deep mining and analysis model based on the configuration affecting factor system, to obtain a factor semantic representation feature of the service surface activity feature for each configuration affecting factor, a factor semantic representation feature for one configuration affecting factor representing a deep feature of semantics of the configuration affecting factor; and
outputting a service policy of the object for the service and policy interpretation information for the service policy based on the factor semantic representation feature of the service surface activity feature for each configuration affecting factor, wherein the policy interpretation information interprets a calculation logic of the service policy.

14. The computer device according to claim 13, wherein the service is an item recommendation service; the configuration affecting factor comprises a virtual resource status factor; and
the performing deep mining and analysis processing on the service surface activity feature in the deep mining and analysis model based on the configuration affecting factor system, to obtain a factor semantic representation feature of the service surface activity feature for each configuration affecting factor comprises:
obtaining, in the service surface activity feature, a virtual resource activity feature of the object associated with the virtual resource status factor, the virtual resource activity feature comprising regional information of the object and an exchange frequency of the object for a target type item, and the target type item being an item having an attribute value greater than a threshold; and
determining a virtual resource status of the object as a sufficient state when a region type to which the regional information belongs is a first region type and the exchange frequency is greater than a frequency threshold, generating a first factor semantic representation feature that reflects the sufficient state, and determining the first factor semantic representation feature as a factor semantic representation feature of the service surface activity feature for the virtual resource status factor; or
determining a virtual resource status of the object as a deficient state when a region type to which the regional information belongs is a second region type or the exchange frequency is less than a frequency threshold, generating a second factor semantic representation feature that reflects the deficient state, and determining the second factor semantic representation feature as a factor semantic representation feature of the service surface activity feature for the virtual resource status factor.

15. The computer device according to claim 14, wherein the configuration affecting factor system comprises a configuration affecting factor Sᵢ, and i is a positive integer; and
the performing deep mining and analysis processing on the service surface activity feature in the deep mining and analysis model based on the configuration affecting factor system, to obtain a factor semantic representation feature of the service surface activity feature for each configuration affecting factor comprises:
performing deep mining and analysis processing on the service surface activity feature in the deep mining and analysis model based on the configuration affecting factor system, to output an initial factor semantic representation feature of the service surface activity feature for each configuration affecting factor;
determining configuration affecting factors other than the configuration affecting factor Sᵢ in the configuration affecting factor system as remaining configuration affecting factors; and
performing semantic constraint processing on an initial factor semantic representation feature of the service surface activity feature for the configuration affecting factor Sᵢ according to initial factor semantic representation features of the service surface activity feature for the remaining configuration affecting factors, to obtain a factor semantic representation feature of the service surface activity feature for the configuration affecting factor Sᵢ.

16. The computer device according to claim 15, wherein there are at least two remaining configuration affecting factors; and
the performing semantic constraint processing on an initial factor semantic representation feature of the service surface activity feature for the configuration affecting factor Sᵢ according to initial factor semantic representation features of the service surface activity feature for the remaining configuration affecting factors, to obtain a factor semantic representation feature of the service surface activity feature for the configuration affecting factor Sᵢ comprises:
determining the initial factor semantic representation feature of the service surface activity feature for the configuration affecting factor Si as a target initial representation feature, and determining an initial factor semantic representation feature of the service surface activity feature for each of the remaining configuration affecting factors as a to-be-fused representation feature corresponding to the target initial representation feature;
determining one of at least two to-be-fused representation features as a target to-be-fused representation feature, and performing fusion processing on the target initial representation feature and the target to-be-fused representation feature, to obtain a fused representation feature corresponding to the target to-be-fused representation feature; and
performing semantic constraint processing on the target initial representation feature based on fused representation features respectively corresponding to the at least two to-be-fused representation features, to obtain the factor semantic representation feature of the service surface activity feature for the configuration affecting factor Sᵢ.

17. The computer device according to claim 16, wherein the performing semantic constraint processing on the target initial representation feature based on fused representation features respectively corresponding to the at least two to-be-fused representation features, to obtain the factor semantic representation feature of the service surface activity feature for the configuration affecting factor Sᵢ comprises:
obtaining an object set, the object set comprising at least two objects to be clustered;
performing clustering processing on the at least two objects based on the target initial representation feature, to obtain a first class cluster distribution result, the first class cluster distribution result comprising a first class cluster and a second class cluster, a class cluster category to which the first class cluster belongs being a first factor category derived based on the configuration affecting factor Sᵢ, a class cluster category to which the second class cluster belongs being a second factor category derived based on the configuration affecting factor Sᵢ, and the first factor category being different from the second factor category;
determining one of at least two fused representation features as a target fused representation feature, and performing clustering processing on the at least two objects based on the target fused representation feature, to obtain a second class cluster distribution result, the second class cluster distribution result comprising a third class cluster and a fourth class cluster, a class cluster category to which the third class cluster belongs being the first factor category, and a class cluster category to which the fourth class cluster belongs being the second factor category;
determining a feature distinguishing attribute of the target initial representation feature for the target fused representation feature according to the first class cluster, the second class cluster, the third class cluster, and the fourth class cluster; and
determining the factor semantic representation feature of the service surface activity feature for the configuration affecting factor Si based on a feature distinguishing attribute of the target initial representation feature for each fused representation feature.

18. The computer device according to claim 17, wherein the determining a feature distinguishing attribute of the target initial representation feature for the target fused representation feature according to the first class cluster, the second class cluster, the third class cluster, and the fourth class cluster comprises:
obtaining a real factor category label corresponding to each of the at least two objects;
combining objects whose real factor category labels are the first factor category, to obtain a first real label class cluster, and combining objects whose real factor category labels are the second factor category, to obtain a second real label class cluster;
determining a first clustering error corresponding to the target initial representation feature based on the first class cluster, the second class cluster, the first real label class cluster, and the second real label class cluster;
determining a second clustering error corresponding to the target fused representation feature based on the third class cluster, the fourth class cluster, the first real label class cluster, and the second real label class cluster; and
determining the feature distinguishing attribute of the target initial representation feature for the target fused representation feature as a feature abnormality distinguishing attribute when the first clustering error is greater than the second clustering error and an absolute value of an error difference between the first clustering error and the second clustering error is greater than a difference threshold; or
determining the feature distinguishing attribute of the target initial representation feature for the target fused representation feature as a feature normality distinguishing attribute when the first clustering error is less than the second clustering error or an absolute value of an error difference between the first clustering error and the second clustering error is less than a difference threshold.

19. The computer device according to claim 17, wherein the determining the factor semantic representation feature of the service surface activity feature for the configuration affecting factor Sᵢ based on a feature distinguishing attribute of the target initial representation feature for each fused representation feature comprises:
determining a set formed by the feature distinguishing attribute of the target initial representation feature for each fused representation feature as an attribute set;
traversing the attribute set; and
if a feature abnormality distinguishing attribute exists in the attribute set, determining a feature constraint attribute of the target initial representation feature as a constraint-deficient attribute, optimizing the deep mining and analysis model based on an absolute value of an error difference, and performing deep mining and analysis processing on the service surface activity feature in an optimized deep mining and analysis model based on the configuration affecting factor system, to obtain the factor semantic representation feature of the service surface activity feature for the configuration affecting factor Sᵢ; or
if a feature abnormality distinguishing attribute does not exist in the attribute set, determining a feature constraint attribute of the target initial representation feature as a constraint-sufficient attribute, and determining the target initial representation feature as the factor semantic representation feature of the service surface activity feature for the configuration affecting factor Sᵢ.

20. A non-transitory computer-readable storage medium, the computer-readable storage medium storing a computer program, and the computer program, when being loaded and executed by a processor, causing the processor to perform:
obtaining a service surface activity feature of an object in a service, and inputting the service surface activity feature to a deep mining and analysis model, the service surface activity feature being a behavior activity feature of the object directly corrected in the service, the deep mining and analysis model being configured to deeply mine one or more factor semantic representation features for a surface activity feature based on a configuration affecting factor system of the service, the configuration affecting factor system comprising one or more configuration affecting factors that affect the surface activity feature;
performing deep mining and analysis processing on the service surface activity feature in the deep mining and analysis model based on the configuration affecting factor system, to obtain a factor semantic representation feature of the service surface activity feature for each configuration affecting factor, a factor semantic representation feature for one configuration affecting factor representing a deep feature of semantics of the configuration affecting factor; and
outputting a service policy of the object for the service and policy interpretation information for the service policy based on the factor semantic representation feature of the service surface activity feature for each configuration affecting factor, wherein the policy interpretation information interprets a calculation logic of the service policy.
